(19) United States
(12) Patent Application Publication
(10) Pub. No.: US 2011/0115702 A1
(43) Pub. Date: May 19, 2011

(54) Process for Providing and Editing Instructions, Data, Data Structures, and Algorithms in a Computer System

(76) Inventor: David Seaberg, Austin, TX (US)

(21) Appl. No.: 13/003,009

(22) PCT Filed: Jul. 9, 2009
(86) PCT No.: PCT/US09/49987

§ 371 Date: Jan. 7, 2011

(30) Foreign Application Priority Data
Jul. 8, 2008 (US) 61134196

(51) Int. Cl. G09G 5/00; G06F 3/033; G06F 3/16; G10L 15/00

(52) U.S. Cl. 345/156; 715/728; 704/249; 704/E15.001

(57) ABSTRACT

A method and system for computer programming using speech and one or two hand gesture input is described. The system generally uses a plurality of microphones and cameras as input devices. A configurable event recognition system is described allowing various software objects in a system to respond to speech and hand gesture and other input. From this input program code is produced that can be compiled at any time. Various speech and hand gesture events invoke functions within programs to modify programs, move text and punctuation in a word processor, manipulate mathematical objects, perform data mining, perform natural language interne search, modify project management tasks and visualizations, perform 3D modeling, web page design and web page data entry, and television and DVR programming.

### CROSS REFERENCE TO RELATED APPLICATION

This application claims the benefit of application Ser. No. 61,134,196 filed Jul. 8, 2008.

### TECHNICAL FIELD

Computer Programming.

### BACKGROUND OF THE INVENTION

Humans naturally express continuous streams of data. Capturing this data for human computer interaction has been challenging because of the vast amount of data and the inherent way humans communicate is far from the basic operations of a computer. The human also expresses something in a way that assumes some knowledge not known by a computer. The human input must be translated in some way that results in meaningful output. To reduce this disparity historically tools such as punch cards, mice and keyboards were used to reduce the possible number of inputs so that human movements such as pressing a key results in a narrowly defined result. While these devices allowed us to enter sequences of instructions for a computer to process, the human input was greatly restricted. Furthermore, it has been shown that keyboard input is much slower than speech input and there is significant time wasted in both verifying and correcting misspellings and moving of the hand between the keyboard and mouse.

Speech recognition in the last 40 years was one technique created widening the range and increasing the speed of computer input. But without additional context speech recognition results in at best a good method for dictation and at worst endless disambiguation. Hand gesture recognition in the last 25 years also widened the range of computer input however, like speech recognition, without additional context the input was ambiguous. Using hand gestures has historically required the user to raise their arms in some way for input tiring the user.

The idea of combining such speech and gesture modalities for computer input was conceived at least 25 years ago and has been the subject of some research. A few computing systems have been built during this period that accept speech and gesture input to control some application. Special gloves with sensors to measure hand movements were used initially and video cameras subsequently to capture body movements. Other sensing techniques using structured light and ultrasonic signals have been used to capture hand movements. While there is a rich history of sensing and recognition techniques little research has resulted in an application that is useful and natural proven by everyday use. Without a different approach to processing computer inputs the keyboard and mouse will remain the most productive forms of input.

Computer programming generally consists of problem solving with the use of a computer and finding a set of instructions to achieve some outcome. Historically, programs were entered using punch cards, magnetic tape, and with a keyboard and mouse. This has resulted in the problem solver spending more time getting the syntax correct so the program will execute correctly than finding a set of steps that will solve the original problem. In fact, this difficulty is so bad that an entire profession of programming had developed. Additionally, many programs are written over and over again as implementations of common requirements are not shared.

### SUMMARY OF THE INVENTION AND ADVANTAGES

This summary provides an overview so that the reader has a broad understanding of the invention. It is not meant to be comprehensive or delineate any scope of the invention. In one aspect of the invention, a method of capturing sensing data and routing related events is disclosed. Computer input can come from many sensors producing input data that must be transformed into useful information and consumed by various programs on a computer system. Speech and gesture input are used in this system as the main input method. Speech input is achieved through a basic personal computer microphone and gesture input is achieved through camera(s). When sensing data is acquired, it is transformed into meaning full data that must be routed to software objects desiring such input. Microphone data is generally transformed into words and camera data is transformed initially into 3D positions of the fingers. This data is recognized by various speech and gesture components that will in turn produce new events to be consumed by various software objects.

In another aspect of the invention, a facility to configure the routing of sensor input and recognition of sensor data to an application. This facility may take the form of a program interface, a standalone graphical user interface, or an interface in a Integrated Development Environment. Example words or gestures to recognize can be made and assigned to specific named events. Further, the data passed to the recognizer and data passed on can be configured. The method of interpretation of events can be selected.

In another aspect of the invention is the method of searching for finger parts for two hands. This method involves searching for light patterns to initially find unique lighting characteristics made by common lighting hand interaction. Hand constraints are applied to narrow the results of pattern matching. After the hand center is estimated, startpoints are determined and each finger is traversed using sample skin colors. Generally the hand movement from frame to frame is small so that the next hand or finger positions can be estimated reducing the required processing power required. Light patterns consist of patterns of varying colors. Part of the pattern to find may be skin color while the other part is a darker color representing a crack between fingers. There are many possible obstructions in traversing a finger. These include rings, tattoos, skin wrinkles, and knuckles. The traversal consists of steps that ensures the traversal of the finger in presence of the obstructions. Knuckle and fingertip detectors are used to determine various parts of the finger. The 3D positions of fingertips are then reported.

In another aspect of the invention is the method of computer programming with speech and gesture input. This involves using an integrated development environment (IDE) that receives speech and gesture events, fully resolves these events and emits code accordingly. When the user performs some combination of speech and gesture, local object and local and internet libraries are searched to find a function matching the input. This results in the generation of instructions for the program. In the case that full matching cannot be found a disambiguation dialog is started. As a example, by touching a variable i and speaking “Add this to this” and touching the List variable A results in instruction A.Add(i). Metadata for various language constructs is used in the matching process. Statements may be rearranged through the speech and gesture matching process.

The desired program can be described in natural language and corresponding program elements are then constructed. Variable, Function, Class, and Interface naming is something that is commonly critiqued. Various methods of naming may be selected via speech and gestures. These include but are not limited to Verbose, TypeVerbose, and Short. For example, a red bag variable may be represented by RedBag, oRedBag, or even RB. Lines of instructions or statements or parts of instructions may be re-arranged in a direct access and manipulation method. Pieces may be temporally stored on fingertip in order re-arrange instructions.

Inheritance of objects is also determined by speech and gestures. The method of programming can be used with any language including assembly and natural language.

In another aspect of the invention, utilizing speech and gestures, punctuation may be added during dictation and blocks of text may be rearranged in a word processing environment. Menu areas also appear from the recognition of speech and gestures. Lists of properties may be changed in a quick manner by touching the property and stating the change or new value. The output may be modified causing the rewriting of current instructions. Various other operations are enabled with this method including the direct manipulation of mathematics, equations, and formalisms. Spreadsheet manipulation, presentation assembly, data mining, hierarchical to-do list execution, game definition, project management software manipulation, data compression, control point manipulation, visualization modification, grammar definition and modification, state machine and sequence diagram creation and code generation, web page design and data entry, Internet data mining, television media programming.

These techniques may be used in a desktop computer environment, portable device, or wall or whiteboard environment.

### BRIEF DESCRIPTION OF THE DRAWINGS

FIG. 1 illustrates the communication architecture, configuration, and hardware components to software objects.

FIG. 2 illustrates an example graphical user interface that can be used to configure a recognizer, route events, route data, and select sensors and interpretation method, and adding handler for events in code. This drawing also shows how example speech words and graphical gestures can be recorded and tested.

FIG. 3 illustrates the process for identifying finger and hand parts.

FIG. 4a illustrates various light patterns that are matched in the process of FIG. 3.

FIG. 4b illustrates a texture filter to identify variations in skin.

FIG. 4c illustrates a fingertip detector.

FIG. 4d illustrates how the process of FIG. 3 works on a hand.

FIG. 5 illustrates the process of traversing a finger for the process in FIG. 3.

FIG. 6 illustrates an example event handler for speech and gesture for an Integrated Development Environment that process speech and gesture events to construct programming language instructions.

FIG. 7 illustrates an example of code development with speech and gesture events along with example metadata and various program information that can be selected or referred to while programming.

FIG. 8 illustrates an example of describing a program and code that is constructed, the parts of speech for a sample speech input and resulting code, and various speech input resulting in the same instruction.

FIG. 9 illustrates the process of changing the naming style of variables and the effect. Illustrates how instructions may be attached to fingers while rearranging code.

FIG. 10 illustrates the process of mapping fields of one object to another, interface metadata, and changing the inheritance map for some classes

FIG. 11 illustrates how gestures are used in dictation and text selection and movement in word processing. This figure also shows how a user may select an object and send it to another person.

FIG. 12 illustrates Menu areas that may appear during a gesture. Here the user selects a circular object and expands fingers and a context menu appears

FIG. 13 illustrates properties that are modified by selecting a property with a hand gesture and speaking the change in value

FIG. 14 illustrates a example of modifying the output of a program that results in changes to the instructions.

FIG. 15 illustrates an example of speech and gestures to indicate that a group of instruction should run in parallel

FIG. 16 illustrates an example of direct manipulation of mathematical entities or formalisms, along with the concept of factoring using speech and gestures.

FIG. 17 illustrates an example of Matrix decomposition or factoring, factoring a number into factors, and combining numbers in to a product

FIG. 18 illustrates an example of direct manipulation of matrix elements selecting a column, performing matrix inversion and transposition using speech or gestures

FIG. 19 illustrates direct random access changing values in a matrix, row and column changes, performing operations on and retrieving characteristic information of a matrix through speech and gestures

FIG. 20 illustrates set operations, construction of category diagrams, and term manipulation of equations using speech and gestures,

FIG. 21 illustrates the use speech and gestures to manipulate a spreadsheet

FIG. 22 illustrates the use of speech and gestures to assemble a presentation

FIG. 23 illustrates the use of speech and gestures to perform data mining steps

FIG. 24 illustrates a hierarchical to-do list and the definition of a game using speech and gestures

FIG. 25 illustrates game definition, in-game instructions, and game interface using speech and gestures

FIG. 26a illustrates the direct manipulation of a Gantt chart and project management data using speech and gestures

FIG. 26b illustrates using speech and gestures to change the compression of data

FIG. 26c illustrates the raising of the palm to pause an application, speech synthesis/dialog, or to begin undoing an operation

FIG. 27 illustrates the selection of examples or selection of menu areas in construction software, the continue and reverse gestures applied to a scrolling list, and the modification of control points in 3D design.

FIG. 28 illustrates an extrusion process, subdivision, and selection of forward and inverse kinematic limits, and axes and link structures.

FIG. 29 illustrates the manipulation of an equation and visualization for a function of time and frequency using speech and gestures

FIG. 30 illustrates the use of speech and gestures to define and modify a grammar

FIG. 31 illustrates direct entry and modification of operational, axiomatic, and denotational semantics, and text file/XML document using speech and gestures

FIG. 32a illustrates the use of speech and gestures in the definition and modification of a state machine resulting in code that can be executed

FIG. 32b illustrates the use of speech and gestures in the definition and modification of a sequence diagram resulting in code that can be executed

FIG. 32c illustrates the use of speech and gestures in the design of a web page.

FIG. 33 illustrates the use of speech and gestures in the description of the web page operation and code modification, and population of web page data

FIG. 34 illustrates using speech and gestures to perform natural language queries and optimization problem definition using internet data

FIG. 35 illustrates entering instructions in television/media to perform recording, playlist modification, and fine, course, and channel direction.

FIG. 36 illustrates entering program instructions in assembly language and in Hardware Description Language(HDL) using speech and gestures,

FIG. 37 illustrates common environments and hardware that can be used in connection with these methods

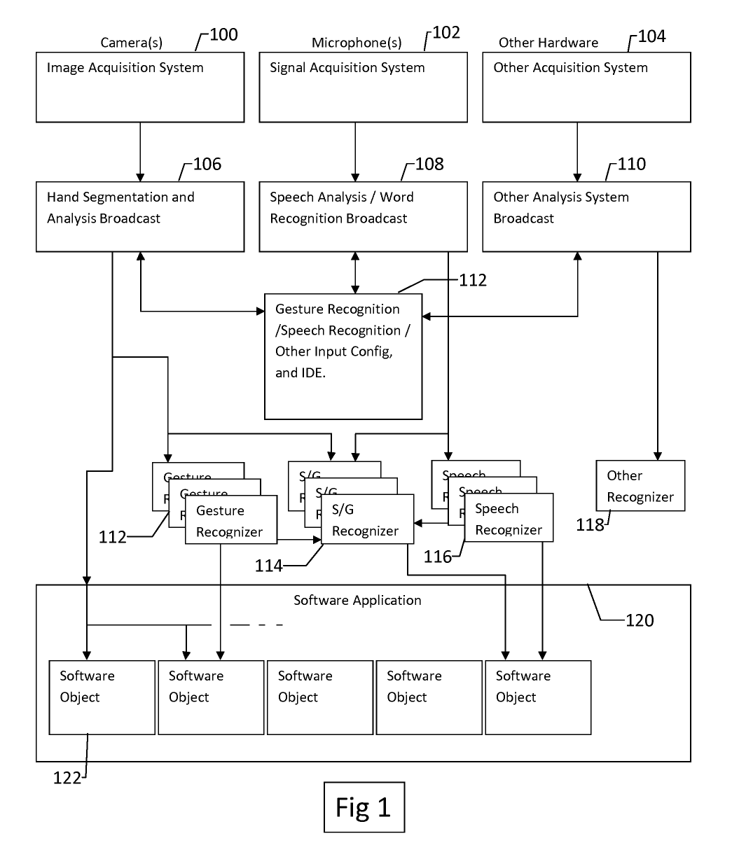

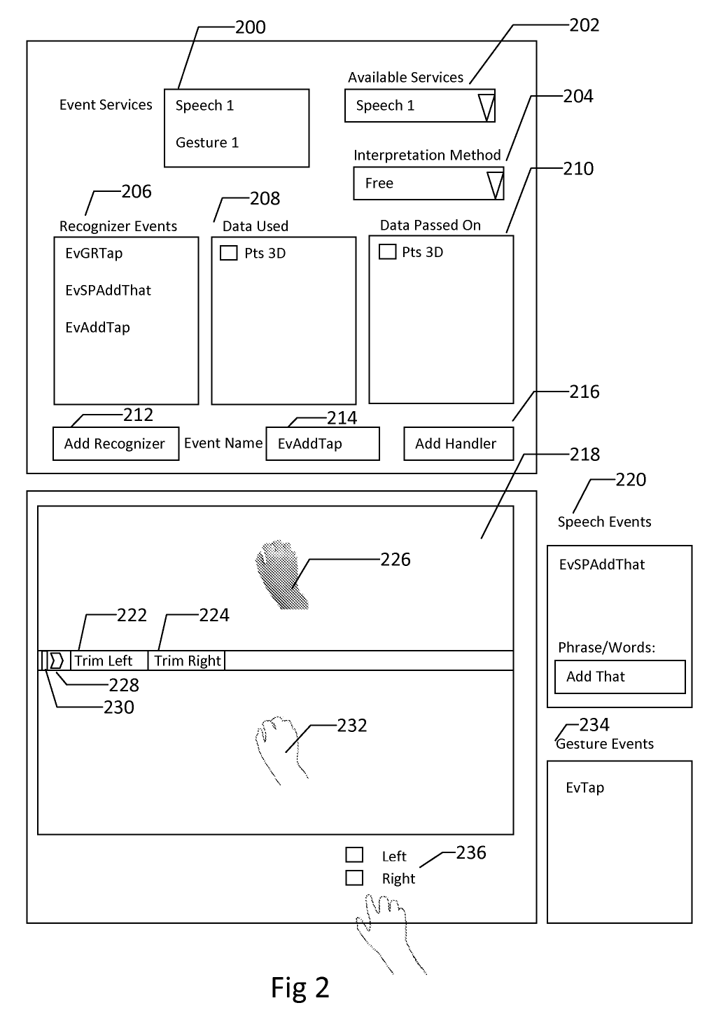

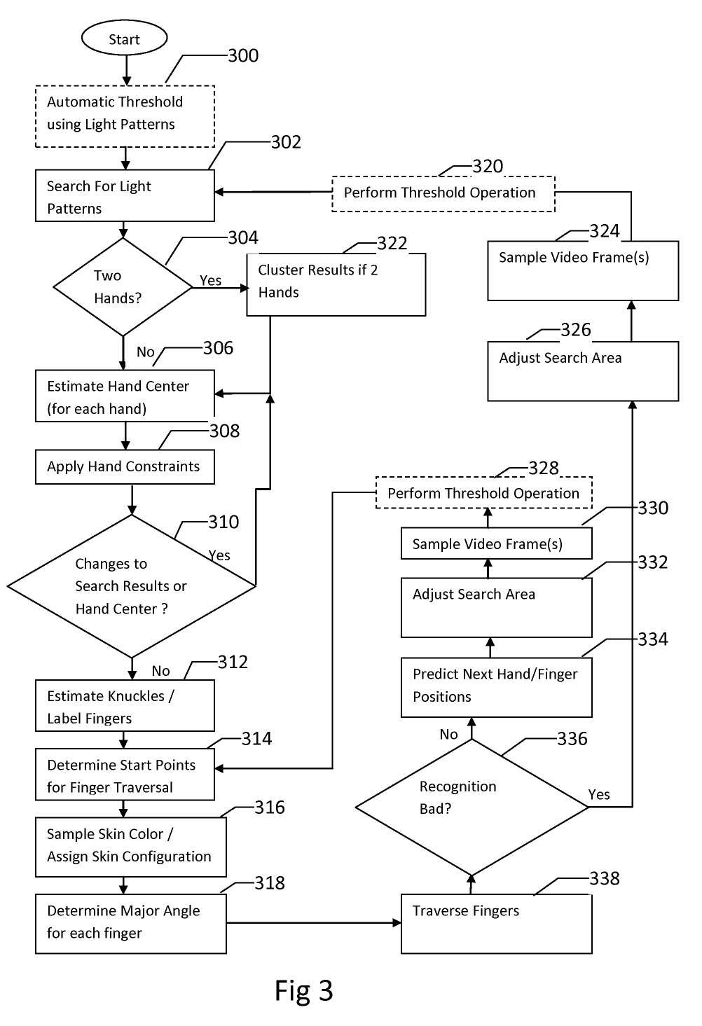

### DETAILED DESCRIPTION OF THE INVENTION

The process, method, and system disclosed consists of a speech recognition system, gesture recognition system, and an Integrated Development patterns found together should form a somewhat linear relationship, that is, the top knuckles are generally linear and thus so should the light patterns.

It should be noted that it is okay but not preferred if there are extra light patterns found. These will be filtered out later in the process. If there are any changes 310 to the center estimate after some light patterns are removed the process is repeated. Then finally the top knuckles are estimated and the fingers are initially labeled along there linear appearance 312. For example, if there are four light patterns, then knuckles are labeled for all fingers and the thumb. If less than four, then they are labeled as fingers with other possible fingers on either side. Then, the starting points 418 for finger traversal are determined 314. Since there is assumed skin area found by the light patterns, a pixel around each side of the skin area serves as a starting point. The skin is sampled and this color is used to begin the finger traversal. This occurs for each finger. The finger is then traversed using an angle called Major Angle. This represents the angle between the top of each light pattern and the hand center estimate. This sets a general direction for traversal.

The fingers are then traversed 338 looking for a goal feature such as a fingertip. If all fingertips were found then the recognition is considered good, else bad. The traversal step is able to estimate fingertips not found and will result in a good recognition even though they were not found.

If the recognition was not bad then a predictive step may be made using a kalman filter or by tracking center values from a previous frame. With 30 frames per second processing most a center value on a finger traversal may serve as the next starting point 334. However, it is preferred that the search area is reduced encompassing the previous area where the light patterns were found before proceeding to the next frame 332, 330.

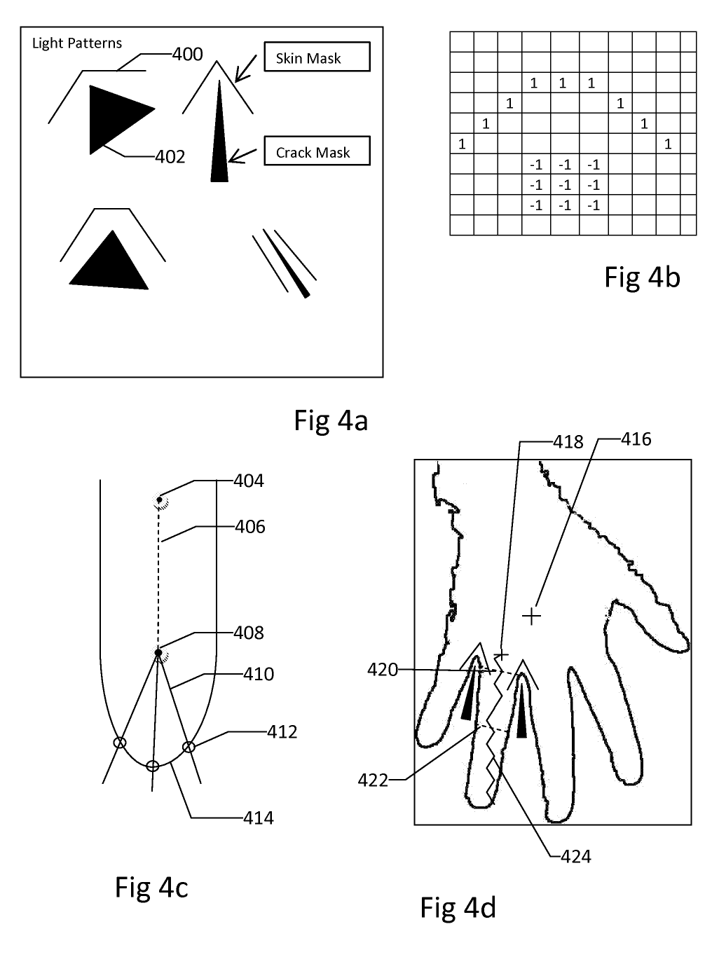

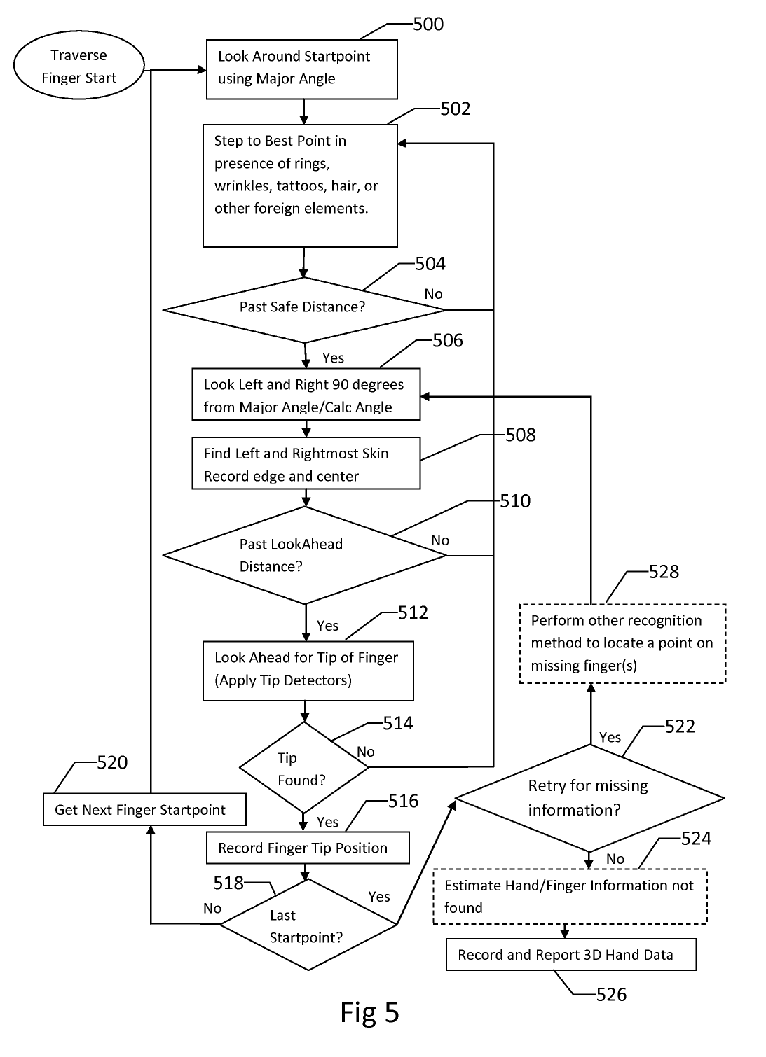

FIG. 5 illustrates the process of finger traversal. The first step in a broad sense it to look around and make sure that there are two sides to the finger. Initially in the traversal this will not be the case because of hand orientation, lighting, and thresholding if performed. The traversal attempts to step to best points in the presence of rings, wrinkles, tattoos, hair, or other foreign elements on the fingers. A safe distance is determined in the following way. A reference line is drawn between the tops of two neighboring light patterns. A best step 502 must be taken in the direction of the major angle until traversing the perpendicular to the major angle results in finding both edges of the fingers. This safe distance line is shown in FIG. 4d 420. Traversal 424 represents the best steps. Once the traversal is past the safe distance 504, both sides of the finger are determined. This may occur at each step or a sampling of steps. The major angle/calc angle 506 represent follow the bone structure of the finger. After some distance, the LookAhead distance 510, a search is done for the goal feature or the fingertip 512. Various tip detectors 414 may be used for this feature. A successful one is shown in FIG. 4c. The center values 404, 408 calculated during the traversal follow the bone structure 406. With each step past the LookAhead point, three additional traversals are made at some configurable angle from the centerline or bone. The angle should be larger for wider fingers and small for smaller fingers such as the smallest finger. If three edges are found then the fingertip has been found. If the tip is not found then the process returns to 502 to take another step. If the tip is found, the fingertip is recorded. If all five tips have been found the data is reported 526.

It can be worth doing an additional type of recognition 528 to locate starting points for traversal on missing fingers. This may include scanning neighboring regions for similar skin colors. If a start point is determined and after it's finger traversal, the resulting fingertip is very near a fingertip already found then the starting point was part of a finger traversed.

After using the final start point for finger traversal missing fingertip may be estimated from previous frames and posture history and hand constraints. Calc Angle is used instead of Major Angle after the safe distance and is represented by line 406 calculated from sample center values.

Gesture and Speech Enabled IDE

The gesture and speech enabled integrated development environment is able to receive 3D hand gestures events and speech events. The development environment is used to construct programs from various components both local to the computer and from a network such as the internet. The IDE assembles these components along with instructions and translates them into a format that can be executed by a processor or set of processors. The IDE has some ability to engage in dialog with the user while disambiguating human input. The IDE need not be a separate entity from the operating system but is a clustering of development features.

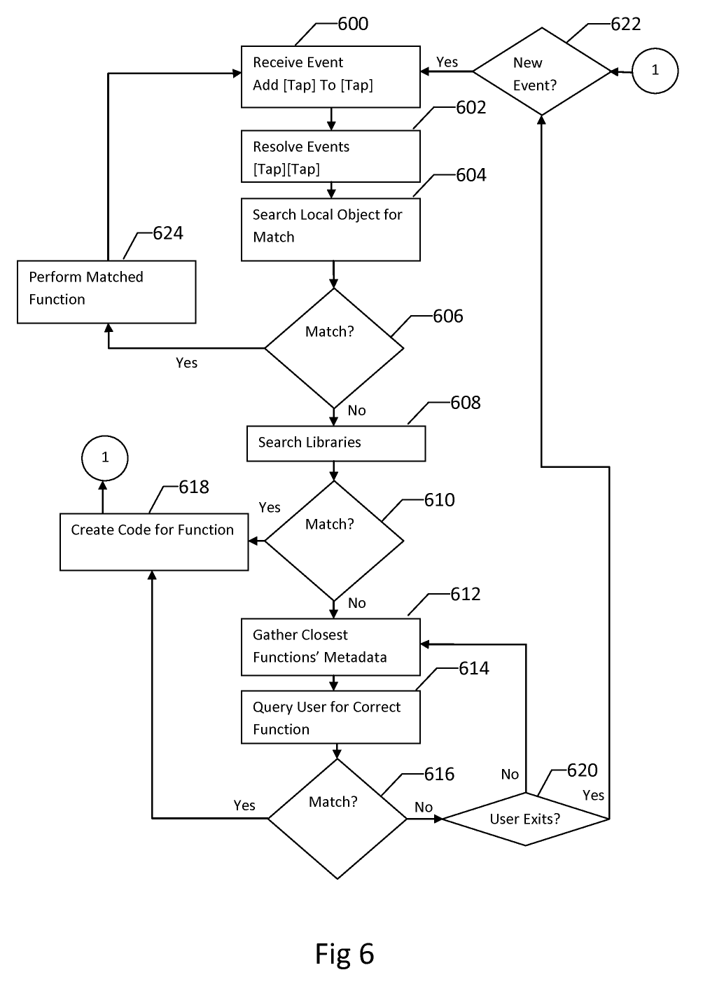

FIG. 6 represents the method of event processing by the IDE. New events arrive 622 and are received 600. Gesture events proceed to be resolved 602 to determine what they are referring to. Some gestures refer to the selection of objects in which case a hit test is performed to determine which object has been selected. For example, for a tap gesture event will invoke a hit test. The IDE must search 606 its local objects to match the event set with metadata for the local objects. If a function matches, that function is executed. This is usually the case for events such as a speech event for the utterance “Create a class”. The IDE will cause the creation of class as specified by the language. Other events such as selection of blocks of code are handled by the IDE. If no match is found then local and network libraries are searched 608. If there is a match then code for that function is created 618. If no match is found a process of interactive disambiguation 612,614,616,620 is invoked. The IDE will attempt to understand the received events by finding the closest meanings and query the user in some way to narrow the meanings until the event can be fully resolved, or, the user exits the disambiguation process. If the meaning is determined by this process, the code for the function is created. This disambiguation process is not confined to just creating code but for any object such as disambiguating the entry of function parameters for a code statement. A user may exit the disambiguation through some utterance or gesture such as the lifting of the hand.

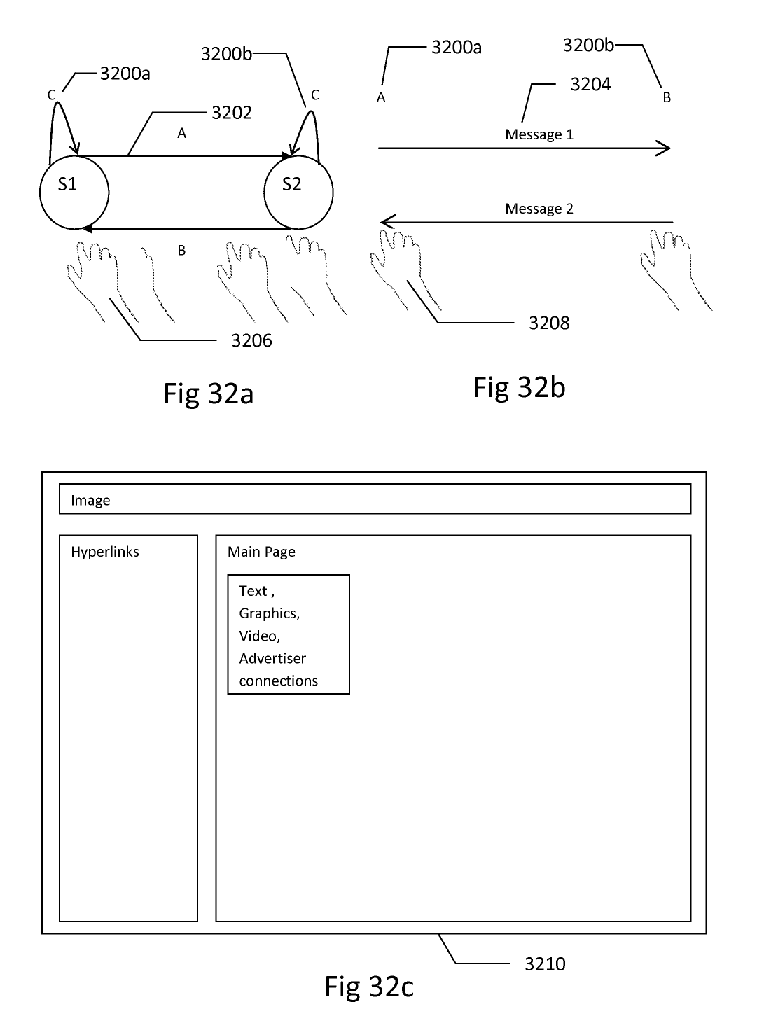

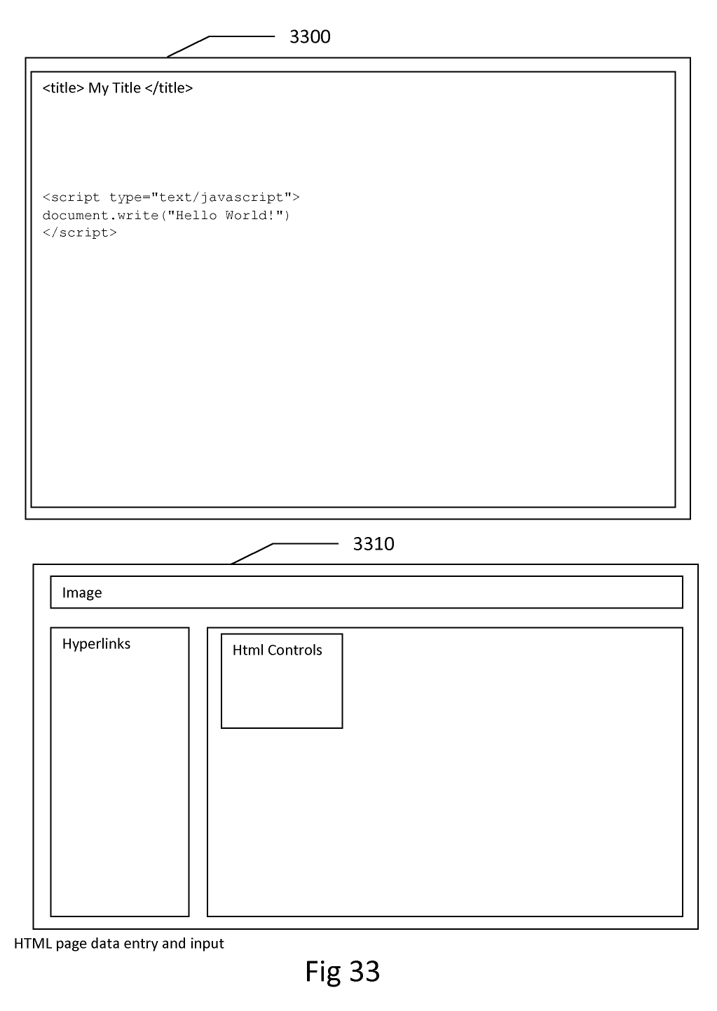

This process also enables the visual construction of programs. It is more natural to work graphically on parts of a program that will be used in a graphical sense, such as a graphical user interface. The speech and gesture based IDE facilitates the construction of such an interface. The user interface can be made up of individual objects each with some graphical component to fully create the interface. This interface may be used locally on a machine or used over a network such as the internet. In the latter case, the html user interface model may be used as shown in FIG. 32c. The programmer may design the interface using a speech and gesture enabled library of objects to create Images, Hyperlinks, Text, Video, and other user interface elements, and further program the functionality of these components in a declarative or imperative way 3300, including giving certain elements the ability to respond to gesture and speech input.

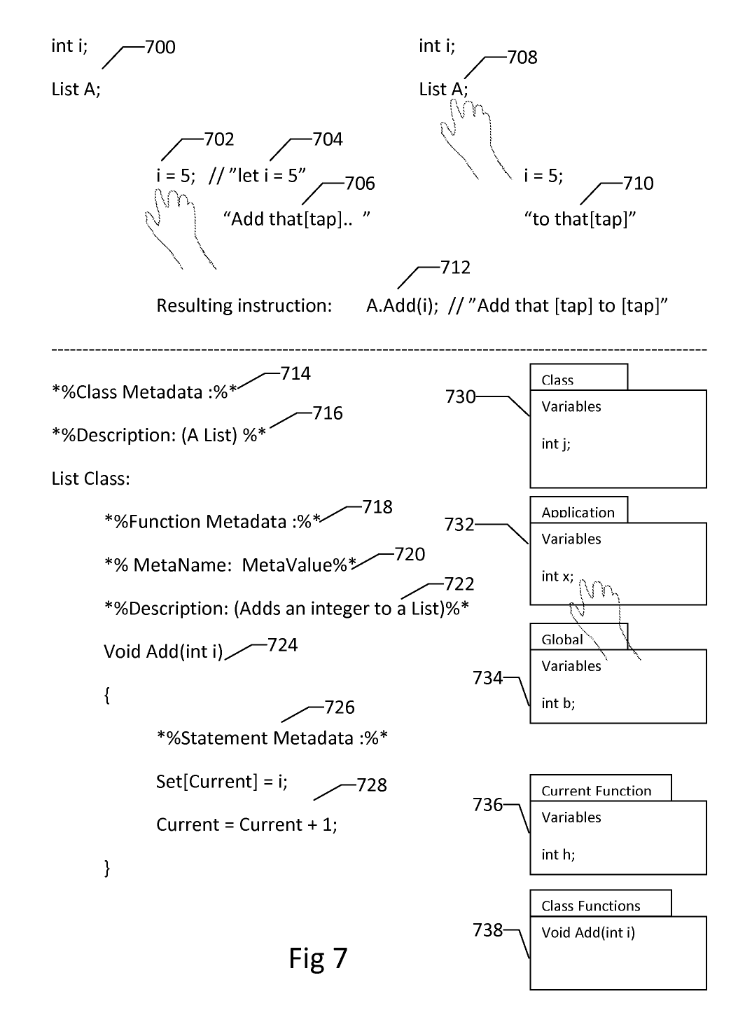

FIG. 7 illustrates one example in the programming process. The user has created a variables i and A 700 and defined i 702 by stating “let i=5”. The user states “Add that” 706 and selects the variable i, which causes a tap gesture event. The user then states “to that” 710 and selects variable A 708 creating a second tap gesture event. The tap events are resolved using hit tests to be variables i and A. This input is then matched to the function Add using the class 714, 716 and function 718,720,722 metadata for a List class. The code is then generated for this function, A.Add(i) 712 which adds an integer to a list A. In the programming process various entities may be referenced through speech and gesture. For example, variables can be referenced not only from the code in view but from the displays of variables, 730,732,734,736,738. The display of entities may vary depending on one particular user's preference and what parts of the program the user is currently working on. The Add function is defined in 724 and has statement metadata 726 and the function statements 728.

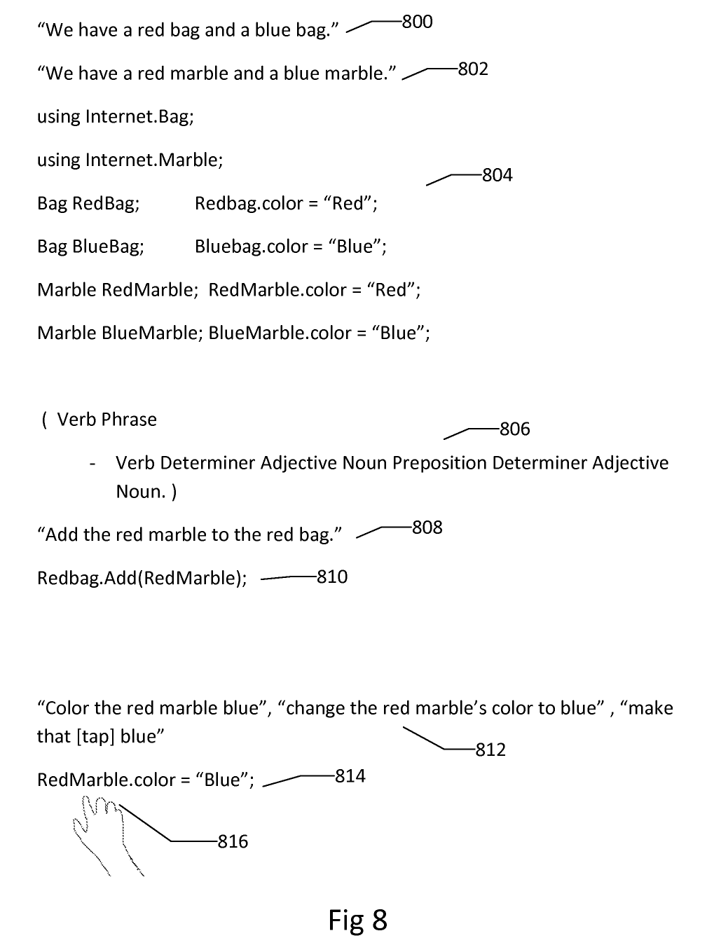

A program can be described in an interactive dictation way allowing the programmer to make some statements about the program and the IDE making some program interpretation. For example in FIG. 8 the user utters sentences 800 and 802. The utterances are parsed and code is produced accordingly. Since the Bag is not defined it uses a common interpretation of a bag from an network or local resource. Two bags are created 804. The bags are colored according to the sentence parse of 800 and 802. The marbles are also created similarly. An example parse is 806 in reference to statement 808. The code is created in a similar way to 712. Many user inputs may result in the same action as shown in 812,814,816. There are many ways to change the color of a marble. The first “Color the red marble blue” is similar to 712 in that a color set property is matched. The second utterance “change the red marble's color to blue” resolves to change a property (color) of the red marble. The third utterance and gesture “make that [tap] blue” 814 resolves again to changing an objects color property to blue. A hit test is performed to resolve the tap gesture. The RedMarble object identifier is found. The specific language and compiler designers have some involvement in how a match is made from the events to the creation of code for a program. For example, if a language does not have classes, the IDE should not try to create one if the programmer utters “create a class”. So the programmer may perform direct entry as in FIG. 7, or may elect to describe how the program works as in FIG. 8 and make modifications as the program is developed.

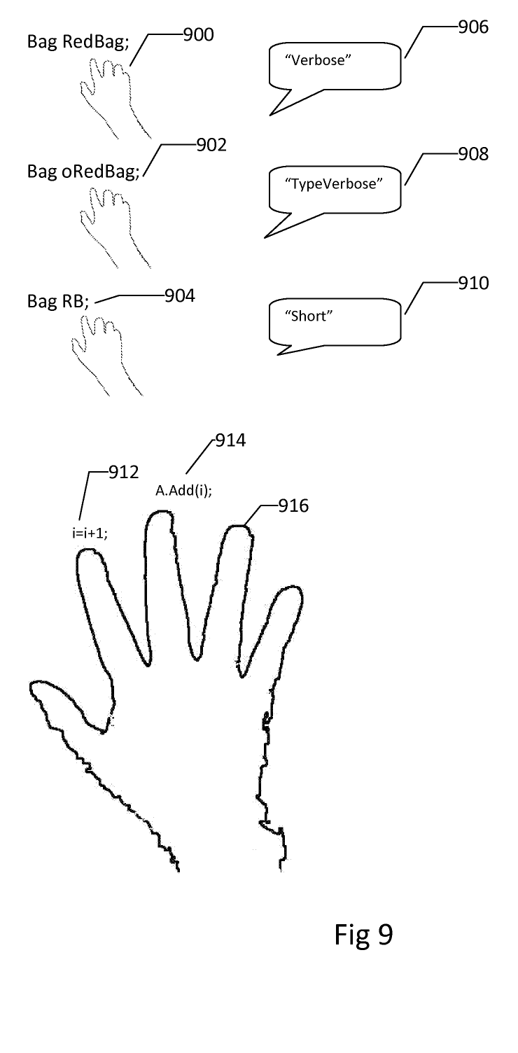

Program modification can take many forms and is fully enabled by speech and gesture input. For example, in FIG. 9, the display style of variables of a program may be changed to suit an individual programmer or some best practice within some group of programmers. Here 900 the programmer selects the variable and states a style change. 900, 902, and 904 illustrate example variable styles for called ‘verbose’, ‘TypeVerbose’, and ‘Short’.

In the arrangement of instructions and program parts, the hand may act as a kind of clipboard storing instructions to be re-inserted while editing as shown in 912,914,916.

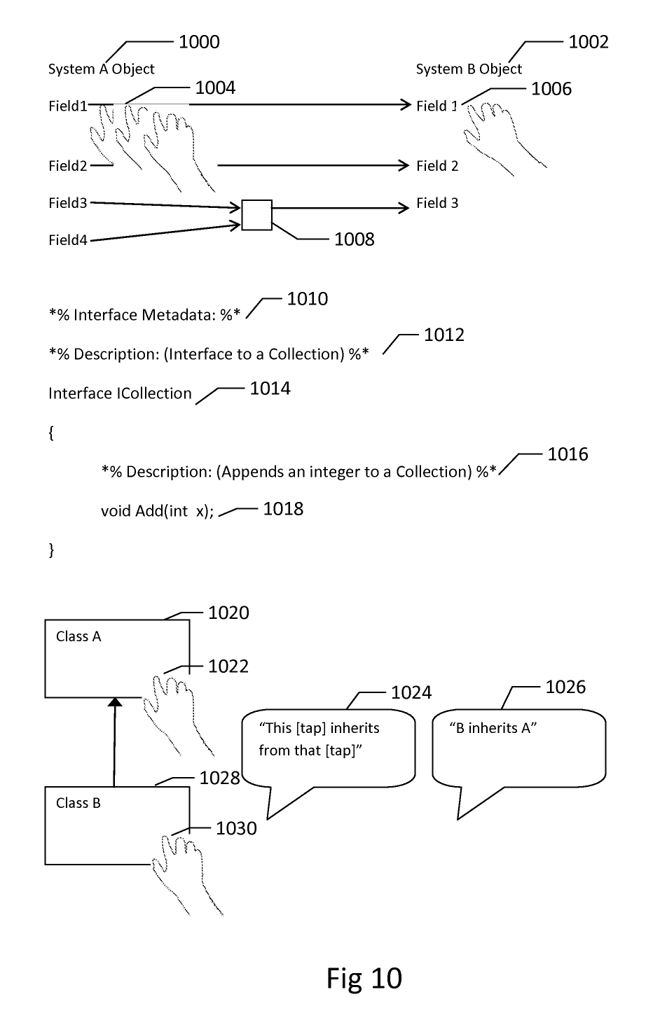

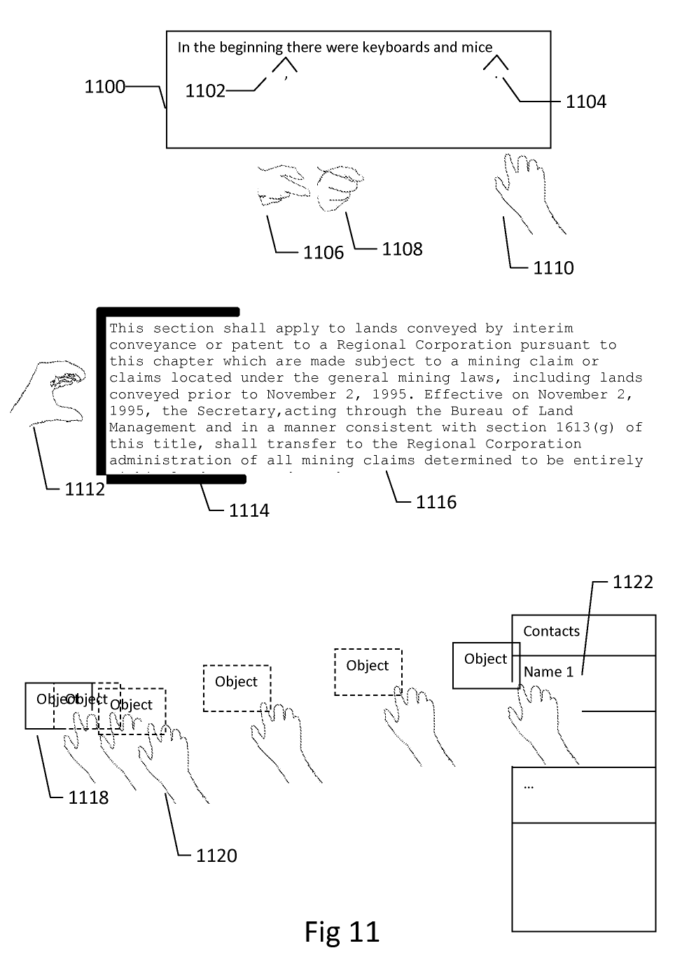

Event matching metadata may be added to any development construct including interfaces 1010,1012. In FIG. 10, an interface for ICollection is defined with interface metadata and function metadata.

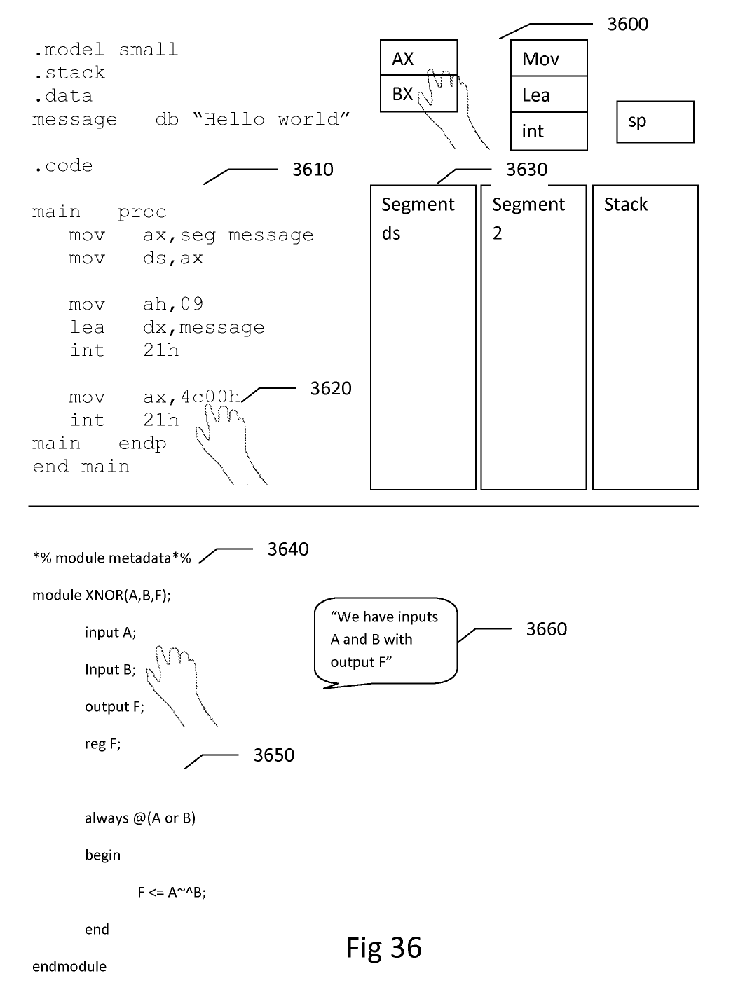

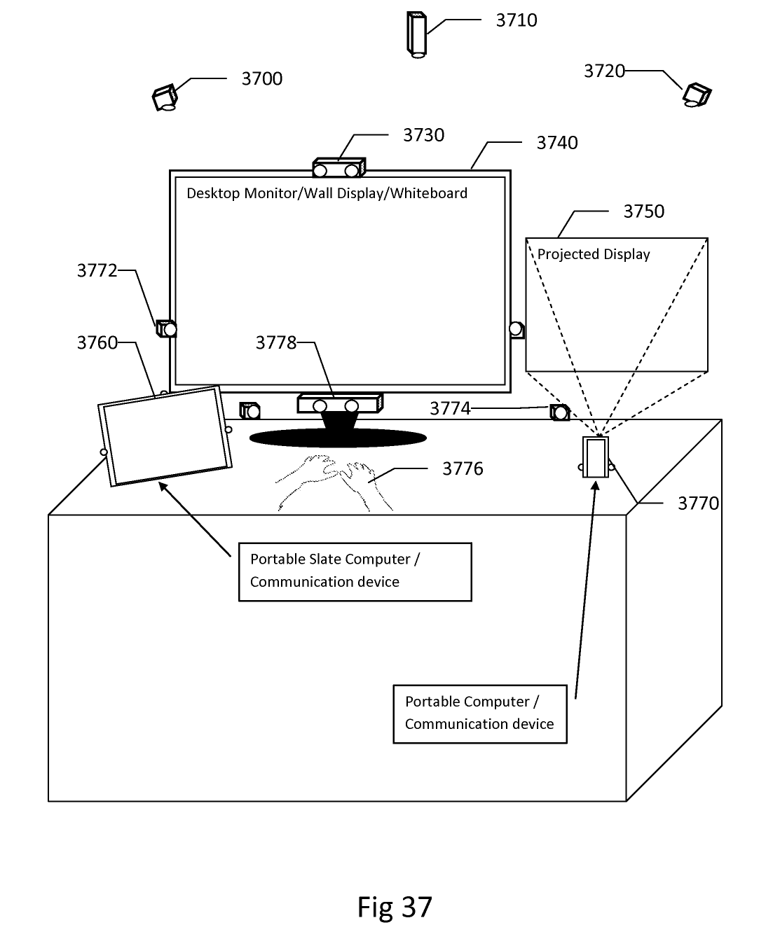

This process is not limited to particular types of language. For example, in FIG. 36 metadata is added to a module in a Hardware Description Language and assembly language.

Fields may be mapped between objects in two systems so that they may exchange data 1000,1002,1004,1006. This can be done using some speech and gesture utterance. 1008 indicates some function required such as concatenating two fields for map to a single field in the other system. A user or programmer may utter “concatenate Field three and four and map it to Field three”. Alternatively, the user may utter “concatenate this [tap] to this [tap] and map it to here [tap]”. This results in both speech and gesture events.

Further illustrated in FIG. 10, the programmer may define and change the inheritance hierarchy for any object using speech and gesture events.

Word Processing

One of the problems with dictation is that it is unclear whether the speaker is desiring direct input, giving commands to a program, or describing what they are dictating and how it is displayed. Using hand gestures along with speech resolves many of these problems. For example, while dictating the sentence “In the beginning, there were keyboards and mice.” The user would normally have to say the words ‘comma’ and ‘period’. But this is awkward. Especially if the sentence was “My friend was in a coma, for a very long period”. Using hand gestures as parallel input to speech as shown in 1100, the sentence is conveyed nicely. Punctuation gestures are performed to insert appropriate punctuation during dictation.

Hand gestures may also be useful in selecting beginning and ending text positions in a paragraph to remove or rearrange the text as shown at 1112,1114,1116.

Sending Data

Simple data transfers are enabled with gesture input. The user selects 1118 an object and drags 1120 the object to a contact name 1122.

Menu Areas

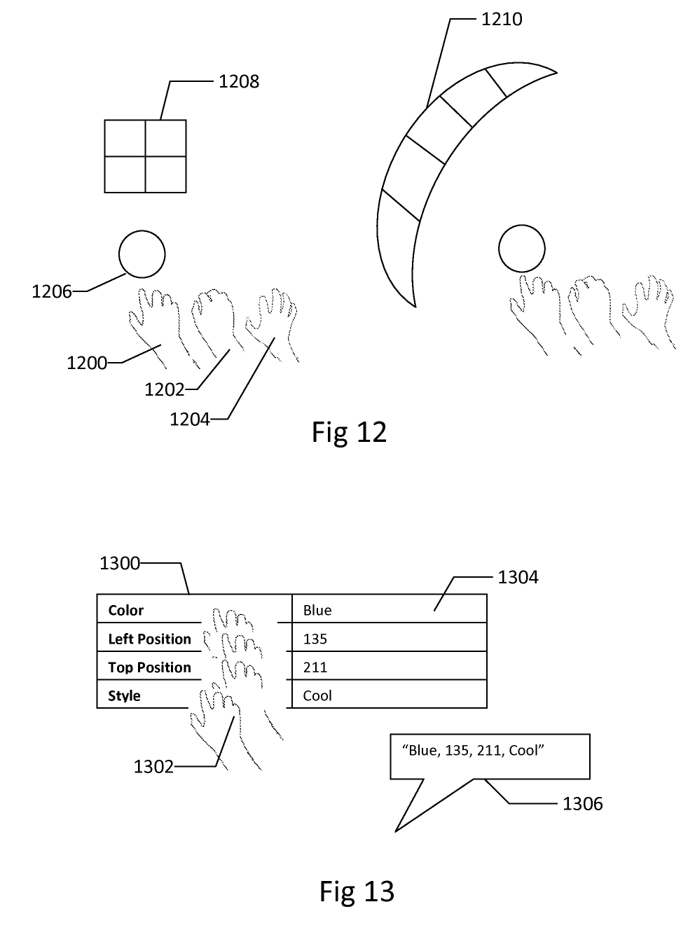

Menu areas are displayed in response to speech and gesture input as indicated in FIG. 12. The user bay select 1200 and object 1206 and perform a spreading or stretching motion 1202 and 1204 invoking a menu area 1208, 1210. The user may then select areas of the menu to perform some operation or selection.

Quick Property Modification

Object property values may be modified in a quick fashion as shown in FIG. 13. Here 1300, a list of properties is displayed and corresponding values 1304. The user may select and state quickly what the new value should be. Here the properties are “Color, Left Position, Top Position, Style”. The user may touch these and utter “[tap]Blue [tap] 135 [tap ] 211 [tap] Cool” 1306 shown without the gesture tap events.

Output Modification

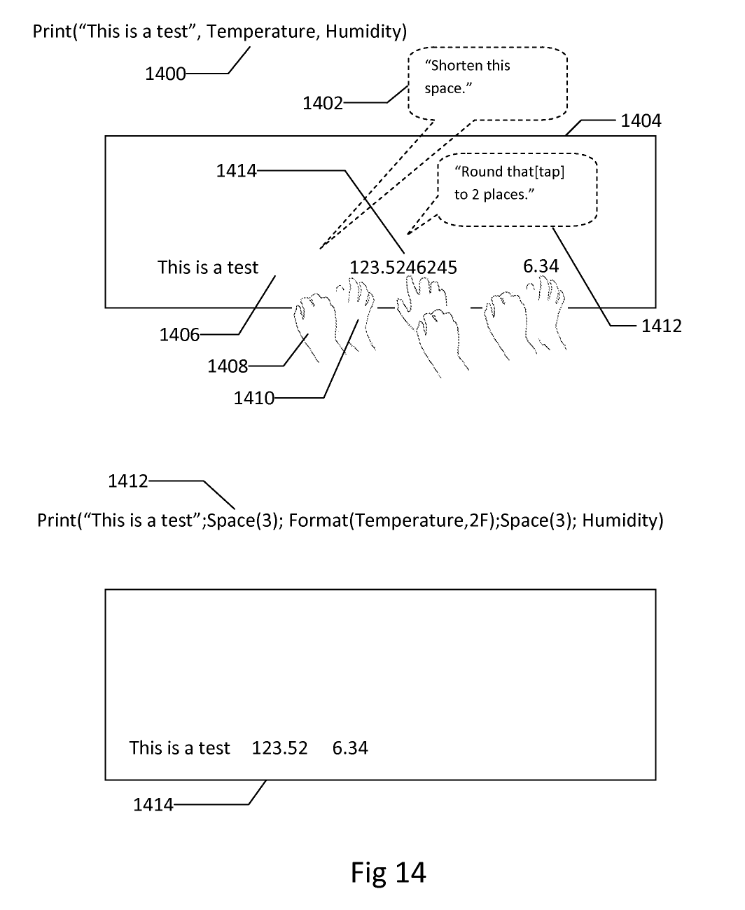

Frequently in program development the output is not as desired. So instead of making blind changes to the program to fix the output, the user or programmer may make changes to the output directly and disambiguate the code changes desired. This is depicted in FIG. 14. A print statement is made 1400 resulting in output 1404. The programmer does not like the spacing and number format of the output. The programmer then may use a combination of speech 1402 1412 and hand gestures 1408, 1410 and 1414 to reduce the space 1406 and round the number 1414. As described, simple selection tap gestures are used. However, other gestures may be used without the speech input with the same result. These gestures can be natural—a contracting of the hand after selection to reduce the space, and swiping the finger after selecting the area to round.

The resulting code is in 1412 and resulting output 1414.

Instruction Execution Location

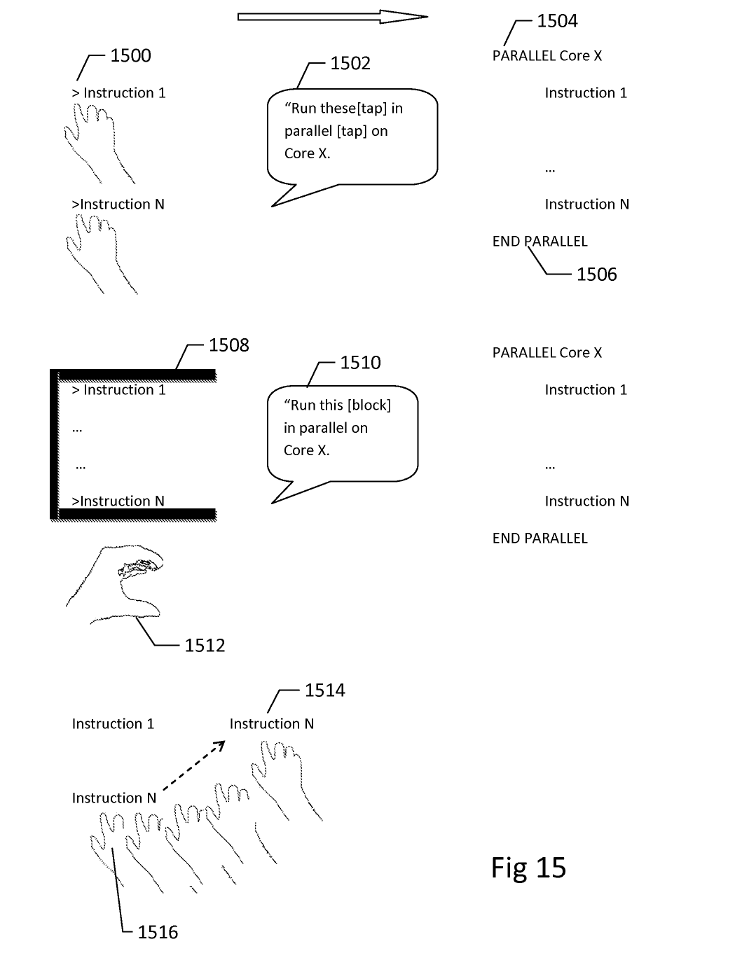

Many times for efficient execution code will need to run in parallel. A programmer may explicitly indicate what instructions should run in parallel and on what processor or group of processors. FIG. 15 illustrates various methods to achieve this. The user may select with a hand gesture 1500 a range of instructions and make an utterance 1502 so that the compiler or runtime knows 1504 1506 to run these in parallel. A second way of achieving the same result is 1508 1510 and 1512. Two instructions may be made to run in parallel by moving them into a parallel position.

Grammar Definition

Grammars 3000 may be defined and changed with speech and gesture events as illustrated in FIG. 30. Grammar development is made with similar speech and hand gesture events as described previously. For example, adding a new expression production results in the short style production ‘expr’. Individual components of the grammar can be selected or accessed 3020 using gestures as described previously.

Assembly Language Development

Programming in assembly language, FIG. 36, is similar to other code development described previously. Menu areas are formed to allow the hand gesture selection of registers, instructions, and memory locations from various segments 3630. Metadata may be added to functions such as 3610 and a combination of speech and gesture input is made to produce a statement such as 3620.

Mathematical Formalism and Operations

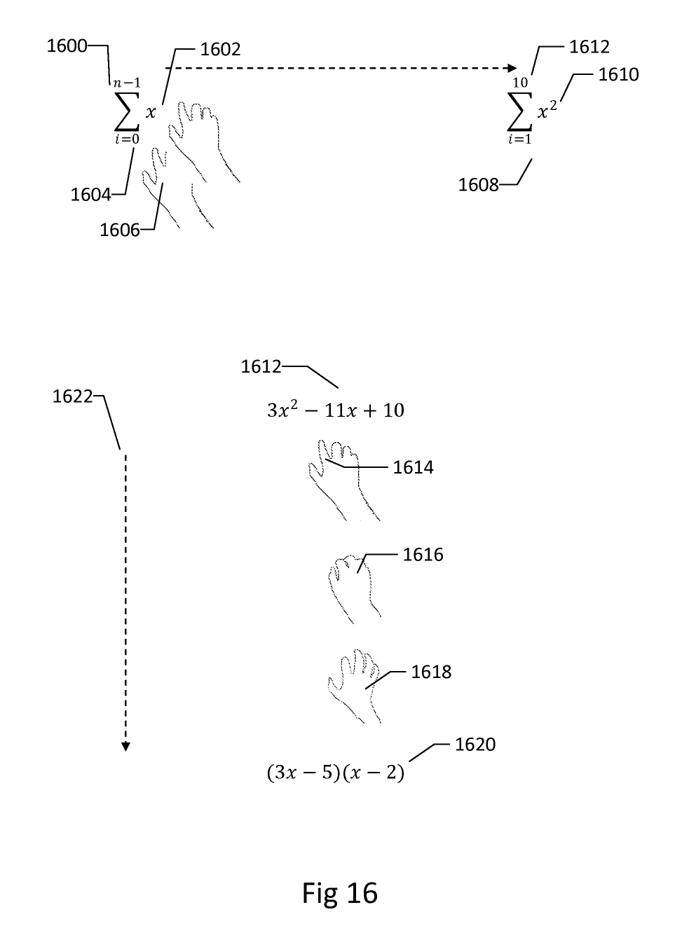

The concise expression of functions and relations are important in mathematics whether they be through some set of symbols and variables or described through natural language. Creating and modifying mathematic entities using a computer has been difficult in the past in part to having to select different parts with cursor keys on a keyboard, or using a mouse. Enabling mathematical objects to respond to speech and hand gesture input alleviates this problem. FIG. 16 thru 20 illustrate examples and methods for manipulating mathematical objects. In 1600 we have a summation that may be modified by selecting various parts and speaking the new values. Here the user selects 1604 and 1602 by hand gestures 1606 and states changes “1 2 10” to change the lower and upper bounds of the summation and the function x.

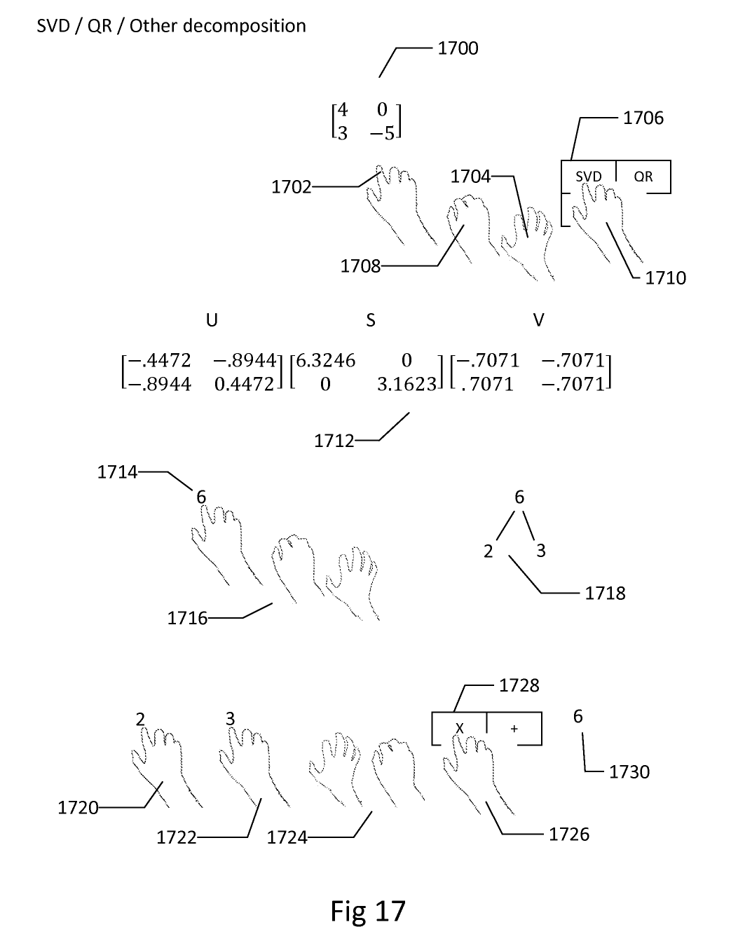

1622 illustrates the gesture progression 1614 1616 1618 of a factoring or decomposition of an equation 1612 into factors 1620. FIG. 17 illustrates the factoring or decomposition of a matrix 1700 by selecting 1702 the matrix and performing a gesture sequence 1708 1704 resulting in the optional display of a menu area 1706 to select a type of decomposition. The resulting decomposition is 1712. Similarly, numbers may be factored or decomposed into factors as shown in 1714 1716 1718, or, combined or fused through the selection 1720 1722 and hand gesture sequence 1724 resulting in the optional display 1728 and selection 1726 to perform a multiplication of the selected numbers, finally resulting in 1730.

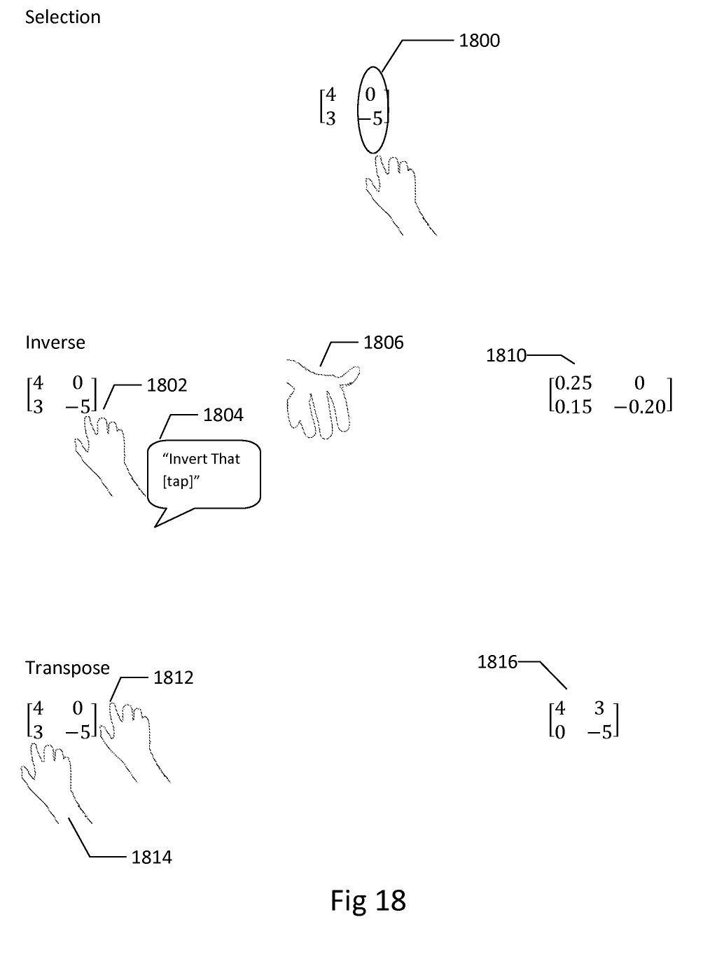

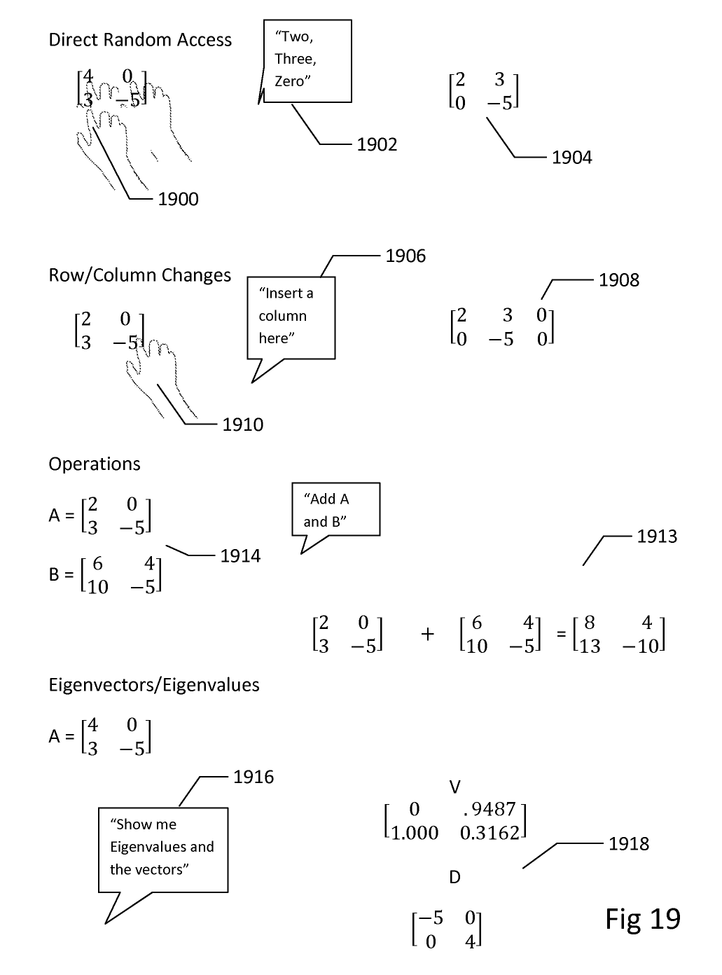

Selection of groups of elements may be made using speech and hand gesture input as illustrated in FIG. 18, 1800 and other operations may be performed through speech and hand gesture input. 1802 1804 1806 1810 indicate an matrix inverse operation. 1812 1814 and 1816 indicate a transpose operation. 1900 1902 and 1904 illustrate direct random access and modification of mathematical objects. 1910 1906 and 1908 illustrate the access and modification of structure of the matrix by inserting a column. Operators may be applied to matrices such as addition illustrated in 1914 and 1912 resulting in 1913. 1916 and 1918 illustrate that matrix system characteristic values and vectors may be determined through the use of speech and gestures.

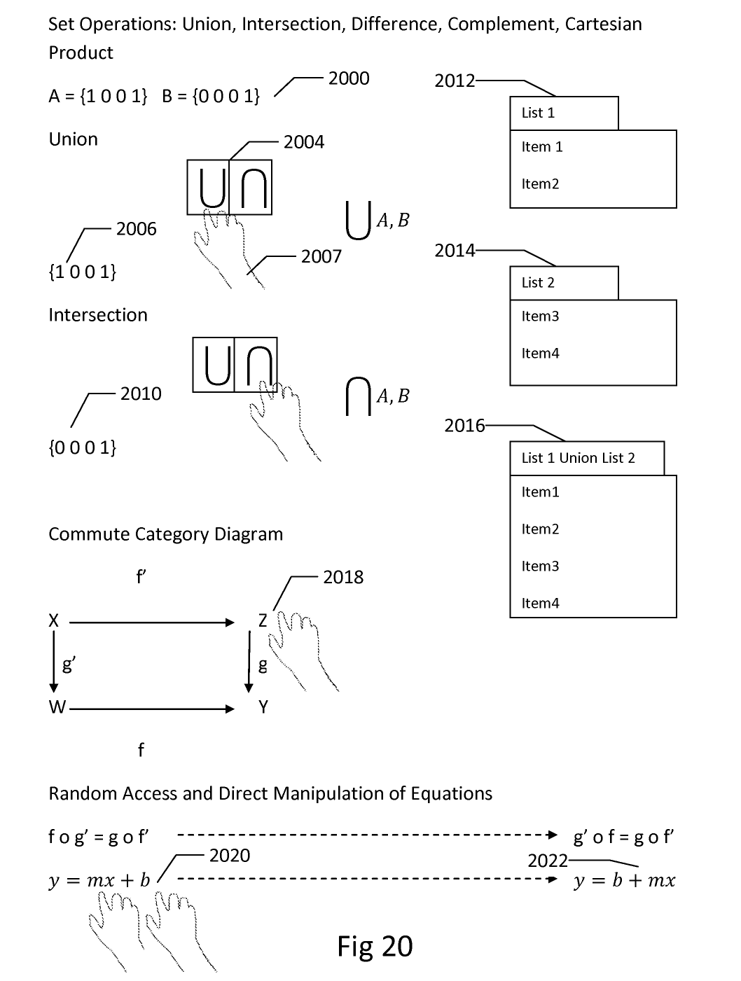

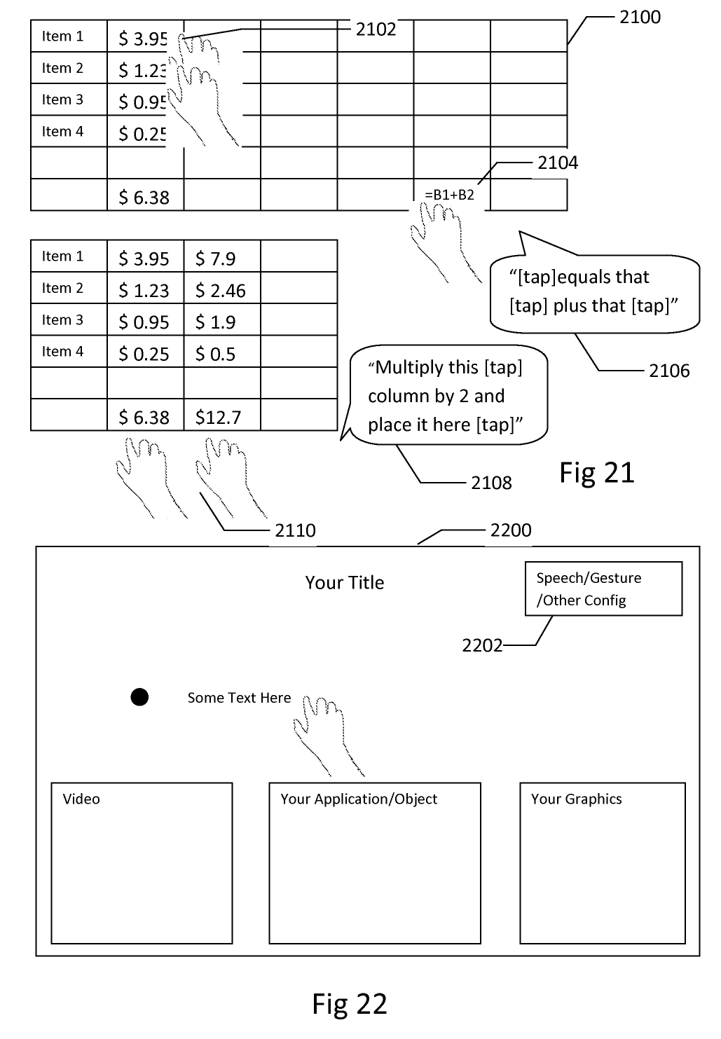

Set operations can be performed through speech and hand gesture input, for example, illustrated in FIG. 20. The creation of union 2006 and intersection 2010 can be made by selecting two sets 2000 and invoking the operation through some speech and gesture input. Similarly sets of data may be handled in a similar way 2012 2014 2016.

Category diagrams 2018 can be construction with speech and gesture input with access to all parts of the diagram. This construction can result in an operational system based on the relation described in the diagram. In other words, creating a diagrammatic relationship results in the creation of code and/or metadata for the code. 2020 and 2022 illustrate the random access and direct manipulation of equations, by changing function composition and rearrangement of terms in an addition operation.

Programming Language Formalisms

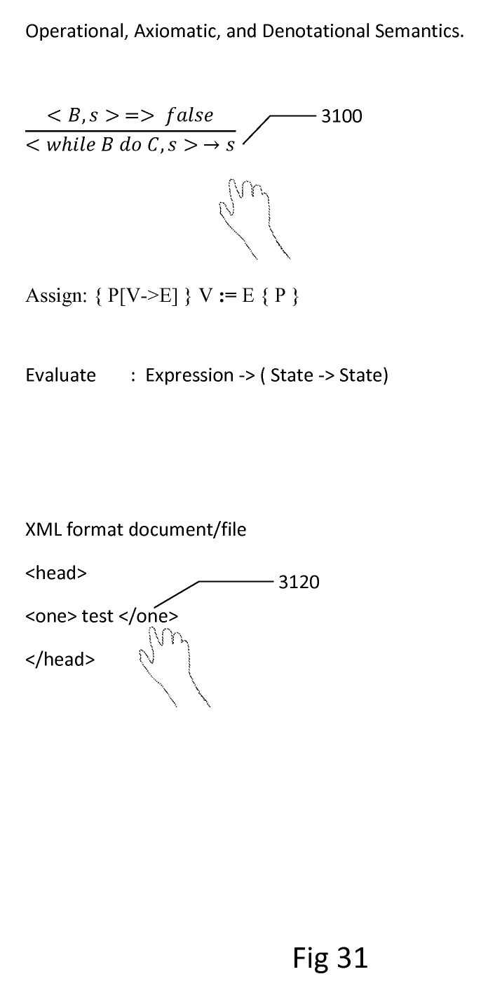

Operational, Axiomatic, and Denotational Semantics may also be created and modified directly using speech and hand gestures. This is illustrated in FIG. 31. The user may provide some speech or gesture input to modify the individual properties of semantics, whether the structure of the semantic or by direct entry.

Spreadsheet

Entering data and functions in spreadsheets can be cumbersome as it is difficult make selections and enter the desired functions using a keyboard and mouse. Usually there is quite a bit of back and forth movement between the keyboard and mouse. With speech and hand gesture input there is little. FIG. 22 illustrates some operations exemplifying this. The user selects a cell, with a hand gesture, to add a function 2104 and makes utterance 2106 additionally selecting two cells 2102. There is no typing, and no large hand movements. Similarly, row or column operations can be done as illustrated in 2108 and 2110.

Presentation Assembly

A presentation 2200 is assembled using speech and hand gesture input. Presentation title, bullet text, and other objects such as graphics, video, and custom application may arranged. The presentation itself is configured 2202 to respond to various events including speech and hand gesture input. Other inputs may include items such as a hand held wand or pointer. These speech and gesture inputs allow the user to interact with onscreen objects during the presentation.

Data Mining

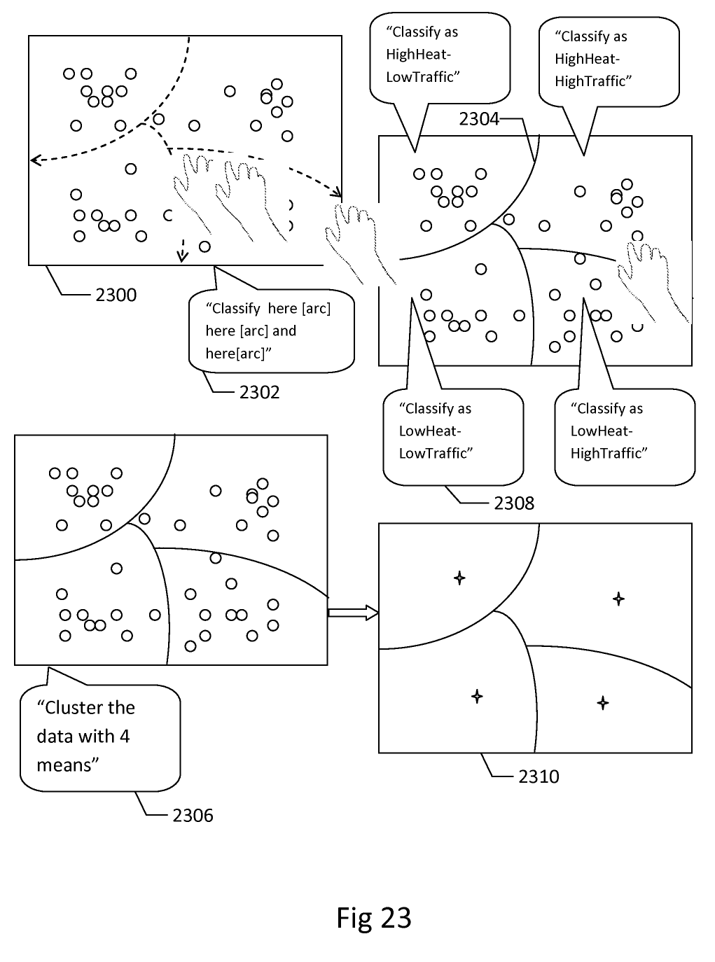

Data mining is complemented with speech and gesture input as illustrated in FIG. 23. The user may retrieve some data, classify the data 2300 using hand gestures to draw arcs and uttering 2302. Further the user may label areas as indicated in 2304. The user may also cluster data through speech and gesture input and indicated in 2306 and 2310.

Hierarchical To-Do List Execution

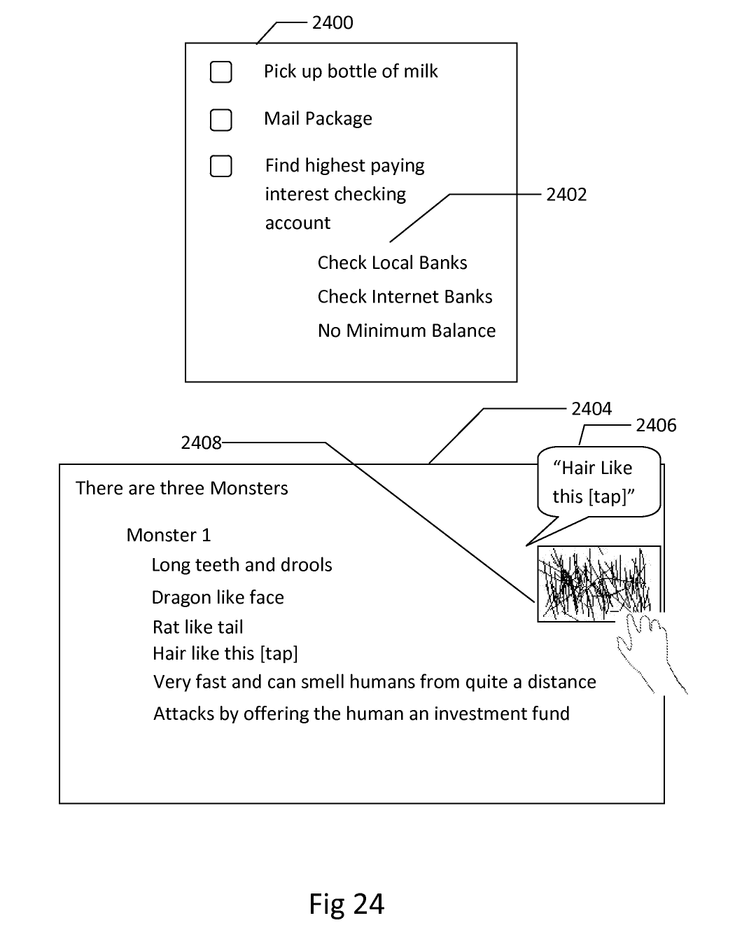

FIG. 24 illustrates a hierarchical to do list where a user may make a gesture to indicate an item location and utter a item, such as “Find highest paying interest checking account”. Now, there may be a number of steps involved in fulfilling this item as indicated in 2400 2402. This forms an optimization problem that the computer or computer agents may assist in. Result disambiguation and requery are done subsequently.

Game Development and Interaction

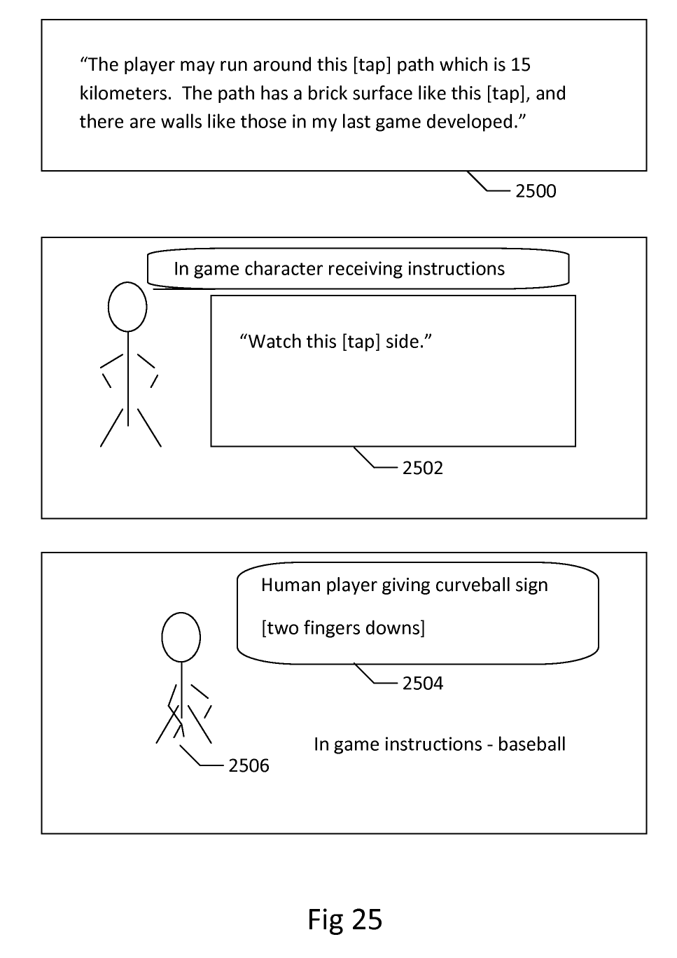

The code for a game may be produced from a hand gesture and spoken description as illustrated in FIG. 24, 2404 2406 and FIG. 25 2500. Here the user makes a reference to a desired property 2406 of an object and selects it 2408 using a hand gesture. A character in the game may receive instructions to follow through play speech and hand gesture movement 2502. A player may give in game instructions. For example as illustrates in 2504 and 2506, a player may give a baseball pitcher the sign for curveball.

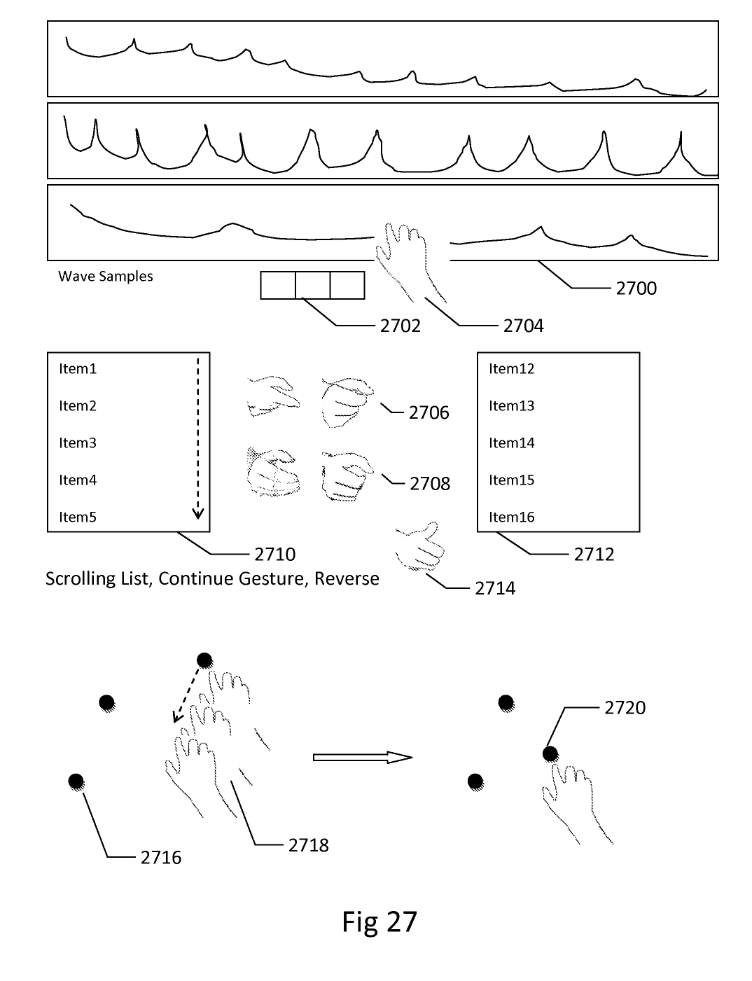

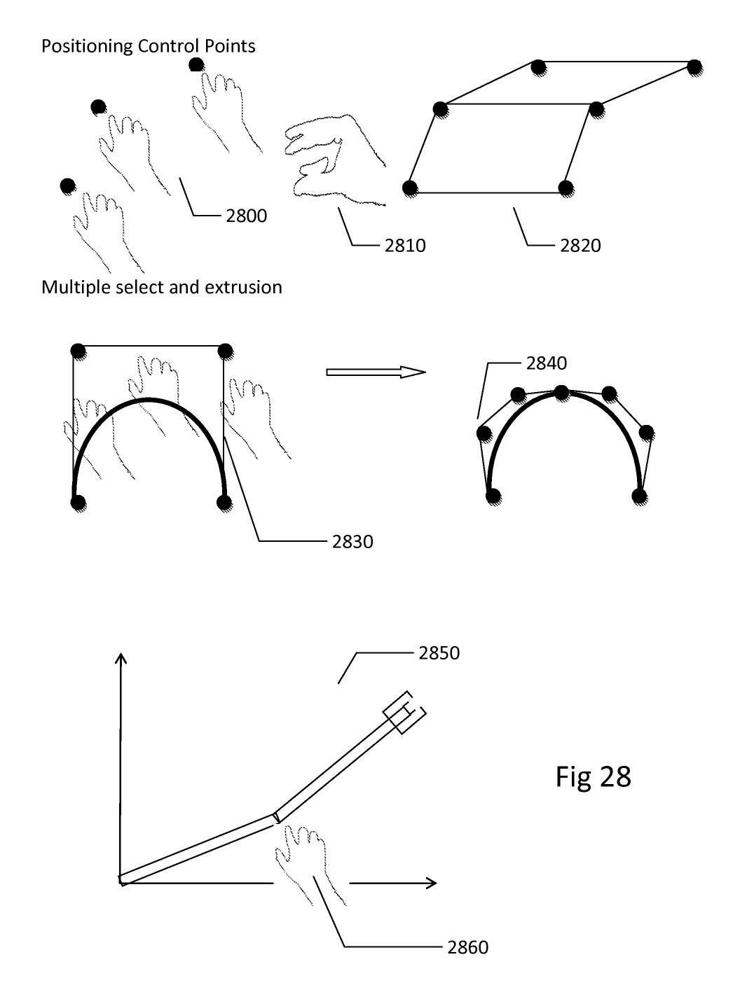

Examples may also be displayed to disambiguate the input as illustrated in FIG. 27. The game developer desires to put a river in a game and wants to select 2704 different wave styles 2700. Examples are shown and the developer may change parameters 2702 for the desired effect.

Project Management

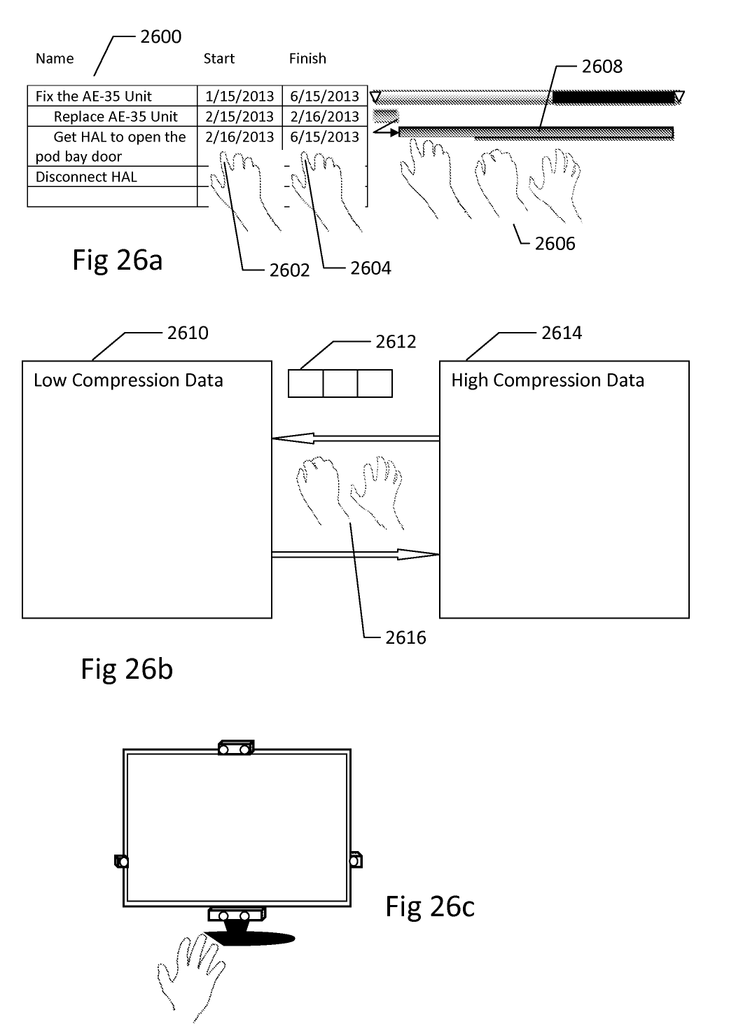

In the project management process, tasks are estimated and tracked. FIG. 26a illustrates the use of hand gestures to select and enter tasks, start and finish dates 2602 2604, and modifying a graphic representing time. Here general expansion and contraction of the hand modifies the finish date or percentage of the task completed.

Data Compression

Data may be compressed interactively using hand gesture and speech input. FIG. 26b illustrates this process. 2610 indicates uncompress or low compressed data and 2616 illustrates the expanding or contracting of the hand to compress the data to 2614. Optionally, speech and compression parameters 2612 may be utilized.

Rate and Direction

Frequently computer users want to continue some operation. This can be achieved using speech and hand gestures as well as illustrated in 2706 through 2712. The user desires to scroll through a list and makes a continue gesture 2706 wagging the finger back and forth with continuous motion. Multiple fingers may wag back and forth for faster or courser increments. The speed of wagging can also determine speed of the scroll. To reverse the direction, a thumb is lifted and the continue gestures may, continue.

Graphics and 3 Dimensional Modeling

Control points in modeling may be manipulated with speech and hand gesture input as illustrated in 2716 2718 and 2720. Here the modeler selects a control point with their finger and moves it to a desired location. Other operations can be done including multiple point selection and extrusion as illustrated in 2800 2810 and 2820, and subdivision as illustrated in 2830 and 2840. Forward and inverse kinematic systems 2850 are constructed from speech and hand gesture input. Joint angle, rate, and torque limits can be defined 2850

Direct Manipulation of Function Parameters and Its Visualization

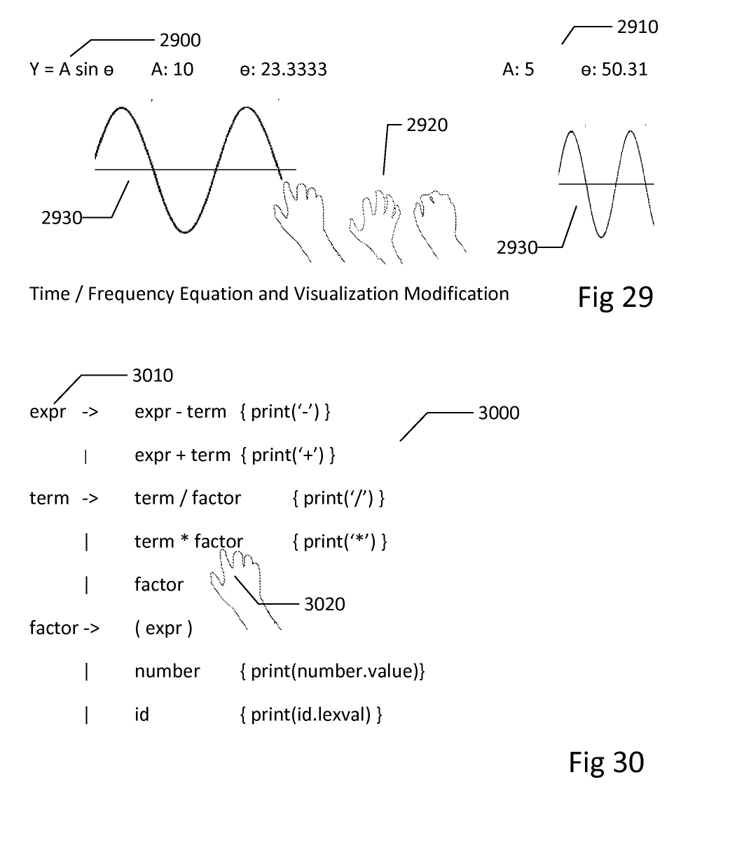

Frequently signals are used as input to a system to test some system function. These signals may be represented by an equation such as 2900. Speech and hand gestures are used to directly modify the variables in the equation or the actual visualization 2920. FIG. 29 illustrates this in detail. Variables A and theta may be changed by selecting them with a hand gesture and uttering the new value. For example, “change A to 5”. Alternatively, a gesture may be made on the visualization 2920 to achieve similar effect. In this case both the magnitude A and the angle theta are modified by the gesture.

An XML document or text file man be directly created or modified through the use of speech and hand gestures and shown in 3120. In this XML file elements may be created, named with direct manipulation of values and attributes.

State Machine and Sequence Diagrams

State machines and sequence diagrams can be created and manipulated 3206 using speech and hand gesture input. In FIG. 32a, two states are created using pointing hand gestures and uttering ‘create two states’. The user then may draw arcs using a finger resulting in edges between states 3200a 3200b 3202 and state the condition resulting in moving from one state to the other. The resulting system is then fully operational and may respond to input.

Similarly, a sequence diagram in FIG. 32b created 3208 through speech and gesture input allows two system A and B 3200a 3200b to communicate through messages 3204. After sequence diagram is defined system is fully operational and may respond to input.

Natural Language Search Query

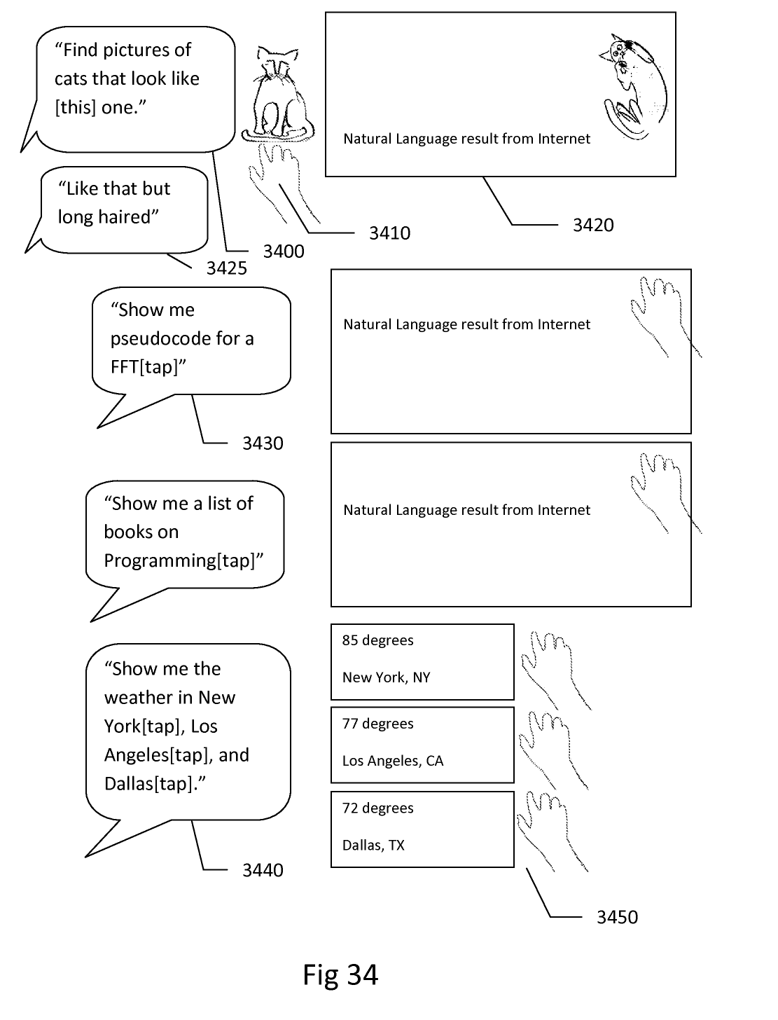

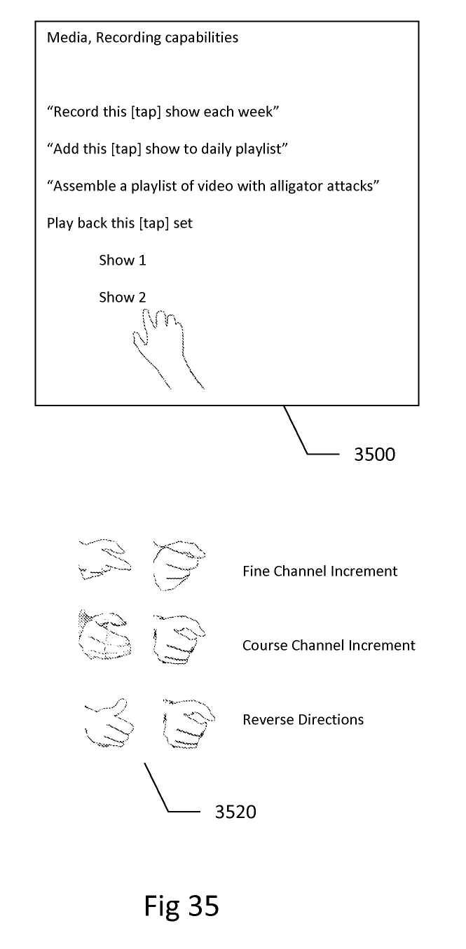

A major part of efficient goal satisfaction is locating blocks of information that reduce the work required. Humans rarely state all of the requirements of some goal and often change the goal along the way in the satisfaction process in presence of new information. Frequently a concept is understood but cannot be fully articulated without assistance. This process is iterative and eventually the goal will become satisfied. Speech and hand gesture input is used in optimization and goal satisfaction problems. A user may want to find pictures of a cat on the internet with many attributes (FIG. 34) but cannot state all of the attributes initially as there are tradeoffs and the user does not even know all of the attributes that describe the cat. For example, it may be the case that cats with long ears have short tails so searching for a cat with long ears and a long tail will return nothing early in the search.

A user may have a picture of a cat and utter 3400 “Find pictures of cats that like this one.” A tap gesture event is recognized as the user touches 3410 a picture of a cat. A result from local and internet resources produces the natural language result 3420. The user may then narrow the results again through an utterance “like that but long haired” 3425.

Other search queries are illustrated in 3430 and 3440 with gesture inputs on the right side 3450. Internet results may also be links with the desired attributes.

Media Recording and Programming

Instructions may be given to devices to manipulate audio and video. In addition to using continuous hand gestures for incrementing and decrementing channel numbers as shown in 3520, speech and hand gestures are used to create lists of recorded audio or video, daily playlists, playing back specific media, and the order of playback, as shown in 3500. Instructions need not be displayed to be stored or executed.

What is claimed is:

1. A method of computer programming comprising:
interpreting hand gestures as programming input; and
interpreting spoken utterances as programming input.

2. The method of claim 1, further comprising receiving and resolving references implied in programming input.

3. The method of claim 1, further comprising searching at least one of local objects, local libraries, and network libraries to match metadata to programming input.

4. The method of claim 1, further comprising identifying functions similar in metadata to programming input intent.

5. The method of claim 1, further comprising a disambiguation process.

6. The method of claim 1, further comprising producing instructions from programming input.

7. The method of claim 1, further comprising execution of a function corresponding to matched metadata with programming input.

8. The method of claim 1, further comprising style naming.

9. The method of claim 1, further comprising defining of inheritance relationship between entities.

10. The method of claim 1: further comprising adding metadata to any programming language element.

11. The method of claim 1: further comprising mapping fields between two system objects.

12. The method of claim 1: further comprising rearranging instructions.

13. The method of claim 1: further comprising parallelizing a set of instructions.

14. The method of claim 1: further comprising defining a grammar.

15. The method of claim 1: further comprising displaying speech and gesture enabled menu areas.

16. The method of claim 1: further comprising entering and modifying operational, axiomatic, and denotational semantics.

17. The method of claim 1: further comprising editing of instructions and data while a program is stopped, paused, or running

18. The method of claim 1: further comprising modifying a set of instructions from the modification of the output of a set of instructions.

19. The method of claim 1: further comprising modifying a set of properties.

20. The method of claim 1: further comprising diagramming an executable state machine

21. The method of claim 1: further comprising diagramming an executable sequence diagram.

22. A method of data and event processing comprising:
allocation of computer system resources to sensor input;
transforming sensor data into broadcast or narrowcast application data for event recognition;
recognizing events from transformed sensor data; and
sending of event notifications and data to a plurality of objects.

23. The method of claim 22: further comprising facilitating the configuration of said data and event processing by means of a programming interface or a speech and hand gesture enabled graphical user interface.

24. The method of claim 22: further comprising defining speech and hand gesture example patterns used by recognizers to generate events.

25. The method of claim 23: further comprising selecting an interpretation method from said programming or said speech and hand gesture enabled graphical user interface.

26. The method of claim 23: further comprising selecting of both left and right hands to be used by the recognizers.

27. The method of claim 23: further comprising defining specific event names.

28. The method of claim 23: further comprising selecting what data is used and routed by objects and recognizers.

29. The method of claim 23: further comprising adding an event handler.

30. The method of claim 23: further comprising adding a recognizer.

31. A method comprising finding parts of hands on one or more hands using light patterns from one or more cameras.

32. The method of claim 31: further comprising determining start points for traversing individual fingers.

33. The method of claim 32: further comprising sampling skin near a finger traversal start point.

34. The method of claim 32: further comprising traversing a finger using a best point in presence of rings, wrinkles, tattoos, hair, or other foreign elements.

35. The method of claim 32: further comprising identifying a finger tip by means of a configurable set of tip detectors.

36. The method of claim 32: further comprising estimating the positions missing fingers.

37. The method of claim 35: further comprising using a safe distance.

38. The method of claim 35: further comprising using a look ahead distance.

39. A system comprising:
at least one image sensor and at least one microphone;
a module to transform sensor data into broadcast or narrowcast application data for event recognition;
a set of speech and hand gesture recognizers;
a set of computer applications enabled to receive speech and hand gesture event input.

40. The system of claim 39, wherein the computer application is an integrated development environment.

41. The system of claim 39, wherein the computer application has facilities determining punctuation and text location within a document from speech and hand gesture input.

42. The system of claim 39, wherein the computer application has facilities wherein speech and hand gesture input determines mathematical operations performed on an object.

43. The system of claim 42, wherein the operations are one of selection and replacement, factoring, combining, decomposing, multiplication, division, addition, subtraction, direct entry, group selection, inverse, transpose, random access, matrix row/column changes, union, intersection, difference, complement, Cartesian product, term rearrangement, and equation and visualization modification.

44. The system of claim 39, wherein the computer application manipulates spreadsheets.

45. The system of claim 44, wherein the spreadsheet application modifies spreadsheet cell data and functions through speech and hand gesture events.

46. The system of claim 39, wherein the computer application builds presentations.

47. The system of claim 39, wherein the computer application performs data mining.

48. The system of claim 39, wherein the computer application performs project management.

49. The system of claim 48, wherein the entry of task names, start and finish dates, and timeline visualizations are manipulated with speech and hand gesture input.

50. The system of claim 39, wherein the computer application performs data compression.

51. The system of claim 39, wherein the computer application performs game application design.

52. The system of claim 51, wherein the game is configured to receive speech and hand gestures for baseball signs.

53. The system of claim 39, wherein the computer application performs continuous actions from a continue hand gesture.

54. The system of claim 39, wherein the computer application performs a reversing action from a reversing hand gesture.

55. The system of claim 39, wherein the computer application performs one of control point movement, multiple control point selection, extrusion, forward and inverse kinematic limit determination.

56. The system of claim 39, wherein the computer application facilitates an internet search.

57. The system of claim 56, wherein the computer application performs natural language query from speech and hand gesture input.

58. The system of claim 39, wherein the computer application facilitates entering data on a web page.

59. The system of claim 39, wherein the computer application facilitates the entry of instructions to record audio and video, determines the channel number, and the order of media playback through speech and hand gesture events.

60. The system of claim 59, wherein the set of gestures comprise fine and course channel increment and decrement, and reverse direction.

61. The system of claim 39, wherein the computer application performs one of pausing of a dialog, or undoing an operation from speech and hand gesture input.

62. The system of claim 39, wherein the computer application facilitates an optimization hierarchical to do list.

63. The system of claim 39: wherein the computer application displays speech and hand gesture enabled menu areas.

64. The system of claim 39: wherein said system is embedded in one of a desktop computer, a communication enabled slate computer, a communication enabled portable computer, a communication enabled car computer, a communication enabled wall display, a communication enabled whiteboard.
